(19) United States
(12) Patent Application Publication
(10) Pub. No.: US 2018/0227035 A1
(43) Pub. Date: Aug. 9, 2018

(54) METHOD AND APPARATUS FOR ROBUST BEAM ACQUISITION

(71) Applicants: Yu-Hsin Cheng, Hsinchu City (TW); Chie-Ming Chou, Zhubei City (TW)

(72) Inventors: Yu-Hsin Cheng, Hsinchu City (TW); Chie-Ming Chou, Zhubei City (TW)

(21) Appl. No.: 15/893,386

(22) Filed: Feb. 9, 2018

Related U.S. Application Data
(60) Provisional application No. 62/456,745, filed on Feb. 9, 2017.

(51) Int. Cl. H04B 7/08; H04B 7/06; H04W 72/04

(52) U.S. Cl. CPC H04B 7/088; H04B 7/0626; H04W 72/042; H04W 72/046; H04B 7/0695

(57) ABSTRACT

A method for beam acquisition between a user equipment (UE) and a transmit-receive point (TRP) radio resource control connected (RRC_CONNECTED) state is disclosed. The method includes measuring, by the UE, reference signals from the TRP to form a channel state information (CSI) measurement report; applying, by the UE, a simplified beam acquisition procedure or a normal beam acquisition procedure, based on at least one of the CSI measurement report and a bitmap from the TRP; wherein the UE obtains an uplink (UL) transmission (TX) beam based on a qualified downlink (DL) reception (RX) beam using beam correspondence, when the simplified beam acquisition procedure is applied.

### CROSS-REFERENCE TO RELATED APPLICATION(S)

The present application claims the benefit of and priority to a provisional U.S. Patent Application Ser. No. 62/456,745 filed Feb. 9, 2017, entitled “METHOD AND APPARATUS FOR ROBUST BEAM ACQUISITION PROCEDURE,” Attorney Docket No. US61871 (hereinafter referred to as “US61871 application”). The disclosure of the US61871 application is hereby incorporated fully by reference into the present application.

### TECHNICAL FIELD

The present disclosure generally relates to wireless communications, and more particularly, to method and apparatus for robust beam acquisition in a wireless communication network.

### BACKGROUND

The 3^{rd} Generation Partnership Project (3GPP) is developing the architecture and protocols for the next generation (e.g., 5^{th} Generation (5G)) wireless communication networks (e.g., new radio (NR)). An NR network strives to deliver sub-millisecond latency and at least 1 Gbps (e.g., 10 Gbps) downlink speed, and support billions of connections. In comparison, a 4^{th} Generation (4G) wireless network, such as a legacy long-term-evolution (LTE) network, can support at most 100 Mbps downlink speed with a single carrier. Thus, an NR network may have a system capacity that is at least 1000 times of the capacity of the current 4G wireless network. To meet these technical requirements, the NR exploits higher frequencies of the radio spectrum in the millimeter wave range (e.g., 1 to 300 GHz) which can provide greater bandwidth.

Extensive studies have been focused on millimeter wave, directional antenna, and beamforming technologies, which are imperative to meet the anticipated 1000 times or more system capacity for the NR requirements. For example, millimeter wave components such as antenna array elements are found suitable for multiple spatial streams, beamforming and beam steering. Since millimeter-wave beams have much narrower beam widths than beams used in the 4G wireless communication networks, techniques for acquiring beam information, such as beam index are important for beam operations in 5G NR wireless networks. Beam acquisition procedure relying on beam sweeping is introduced as a method for finding a qualified beam for beamforming. Both a transmit-receive point (TRP) and a user equipment (UE) have to perform beam acquisition for determining qualified transmission (TX) and reception (RX) beams.

FIGS. 1A and 1B illustrate normal beam acquisition procedures on the UE side for downlink (DL) and uplink (UL) transmissions, respectively.

As shown in diagram 100A of FIG. 1A, for beam acquisition on the UE side for DL transmission, UE 120 needs to perform DL RX beam sweeping to find a qualified beam for DL RX. For example, UE 120 sweeps through all possible beam directions (e.g., beam_{DLRX}1 through beam_{DLRX}3) to detect signals from TRP 160, while TRP 160 transmits reference signals in various beam directions (e.g., beam_{DLTX}1 through beam_{DLTX}5) to UE 120. As such, each of beam_{DLRX}1 through beam_{DLRX}3 is used to detect all of beam_{DLTX}1 through beam_{DLTX}5 from TRP 160 to find a qualified beam for DL RX.

As shown in diagram 100B of FIG. 1B, for beam acquisition on the UE side for UL transmission, UE 120 may need to perform UL TX beam sweeping to find a qualified beam for UL TX. For example, UE 120 sweeps through all possible beam directions (e.g., beam_{ULTX}1 through beam_{ULTX}3) to transmit signals from UE 120 to TRP 160, while TRP 160 uses a fix UL RX beam for detection, until all the UL RX beams (e.g., each of beam_{ULRX}1 through beam_{ULRX}5) on the TRP side have been used. Thereafter, TRP 160 sends a message to UE 120 to indicate the appropriate/qualified UL TX beam based on the measurement results.

The beam acquisition procedures discussed above cost a significant amount of resources (e.g., measurement power and time), especially when there are an increasing number of beams that can be chosen on both the TRP and UE sides as the beam widths are getting narrower. To simplify the procedures for beam acquisition, a new capability, beam correspondence (BC), has been proposed by the 3GPP to assist and save resources during the beam acquisition procedures in the next generation wireless networks, such as 5G NR. Beam correspondence allows the UE to determine a RX beam by beam information (e.g., beam index) of a qualified TX beam, and allows the TRP to determine a TX beam by beam information (e.g., beam index) of a qualified RX beam, for example. Beam correspondence can be held by both the UE and the TRP.

It should be noted that, also only the normal beam acquisition procedures on the UE side for downlink (DL) and uplink (UL) transmissions are, respectively, shown in FIGS. 1A and 1B, the beam acquisition procedures on the TRP side may use similar methods.

FIG. 2 shows a simplified beam acquisition procedure for both DL and UL transmissions on the UE side. For example, if the UE holds beam correspondence, the UE can recognize a qualified UL TX beam without performing UL TX beam sweeping after the UE finds or identifies a qualified DL RX beam. Moreover, if the UE holds beam correspondence, the UE can also determine a qualified DL RX beam once the UE chooses a qualified UL TX beam.

As discussed above, beam correspondence is envisioned as a device capability, and may have special importance to the UE side. For example, a UE with BC can reduce the amount of resources spent during beam acquisition in both an initial access phase and in radio resource control connected (RRC_CONNECTED) state, as compare to UEs without BC. Since beam correspondence is introduced as a device capability, whether a UE holds BC or not is only depended on hardware calibration (e.g., antenna array, RF circuit, etc.). However, in certain instances (e.g., a UE traveling at high speed or in a dense urban environment), the beams obtained based on beam correspondence can be misaligned thus rendered unfit for TX or RX. For example, when a UE desires to perform beam acquisition on a high-speed train during an initial access phase, the UE needs to perform DL RX beam sweeping to find a qualified DL RX beam first. Then, if the UE does not hold BC, the UE needs to perform UL TX beam sweeping during UL TX beam acquisition to obtain a qualified UL TX beam. On the other hand, if the UE holds BC, the UE may transmit a random access channel (RACH) preamble upon the UL TX beam indicated by the corresponding DL RX beam. However, due to high speed, the location where UE transmits the RACH preamble may be far away from the location where the UE performed the DL RX beam acquisition. As a result, the beam correspondence capability may be greatly compromised or rendered ineffective.

FIG. 3 illustrates a problem of UE beam acquisition on a high-speed train with a UE having BC capability. It should be noted that this problem exists not only in the initial access phase but also in RRC_CONNECTED state.

As shown in FIG. 3, in normal speed, UE 320 performs beam sweeping to find a qualified TX (or RX) beam 398. UE 320 may then obtain the corresponding RX (or TX) beam using BC. As UE 320 travels at normal speed, the distance UE 320 traveled during the beam acquisition process may be distance 398A. Also, the relative position between TRP 360 and UE 320 does not change drastically when UE 320 is travelling at normal speed. As such, the RX (or TX) beam indicated by BC is sufficient to qualify for the intended operations.

However, in high speed, UE 320 performs beam sweeping to find a qualified TX (or RX) beam 398. UE 320 may then obtain the corresponding RX (or TX) beam using BC. As UE 320 travels at high speed, the distance UE 320 traveled during the beam acquisition process may be distance 398B, which is significantly longer than distance 398A. Also, the relative position between TRP 360 and UE 320 changes quite drastically when UE 320 is travelling at high speed. As such, the RX (or TX) beam indicated by BC may no longer be qualified for the intended operations, for example, due to beam misalignment. The UE then needs to perform the normal beam acquisition procedure to reselect a qualified TX and RX beam pair. Such reselection causes additional resources because the UE has to perform another beam acquisition procedure. For example, the UE with BC capability may first perform a simplified beam acquisition procedure (as shown in FIG. 2) and obtain a corresponding beam information by BC indication. When the UE realizes that the corresponding beam obtained based on BC indication is no longer qualified for the intended transmission or reception, the UE has to perform a normal beam acquisition procedure in order to obtain a qualified beam (as shown in FIG. 1A or 1B).

Therefore, there is a need in the art for improving the robustness of the beam acquisition procedure for UE with BC capability, for example, by taking channel state information into consideration.

### SUMMARY

The present application is directed to method and apparatus for robust beam acquisition.

### BRIEF DESCRIPTION OF THE DRAWINGS

FIGS. 1A and 1B illustrate normal beam acquisition procedures on the UE side for downlink (DL) and uplink (UL) transmissions, respectively.

FIG. 2 shows a simplified beam acquisition procedure for both DL and UL transmissions on the UE side, according to an exemplary implementation of the present application.

FIG. 3 is a diagram illustrating UE beam acquisition using beam correspondence at normal and high speed, according to exemplary implementations of the present application.

FIG. 4A is a diagram illustrating a beam acquisition procedure based on UE-measured channel state information (CSI) monitoring in an access phase with a UE having beam correspondence capability, according to an exemplary implementation of the present application.

FIG. 4B is a flowchart illustrating one or more actions taken by a UE for beam acquisition based on UE-measured CSI monitoring in an initial access phase with the UE having beam correspondence capability, according to an exemplary implementation of the present application.

FIG. 4C is a flowchart illustrating one or more actions taken by a TRP for beam acquisition based on UE-measured CSI monitoring in an initial access phase with the UE having beam correspondence capability, according to an exemplary implementation of the present application.

FIG. 5A is a diagram illustrating a beam acquisition procedure based on broadcast information from a TRP in an initial access phase with a UE having beam correspondence capability, according to an exemplary implementation of the present application.

FIG. 5B is a flowchart illustrating one or more actions taken by a UE for beam acquisition based on broadcast information from a TRP in an initial access phase with the UE having beam correspondence capability, according to an exemplary implementation of the present application.

FIG. 5C is a flowchart illustrating one or more actions taken by a TRP for beam acquisition based on broadcast information from the TRP in an initial access phase with the UE having beam correspondence capability, according to an exemplary implementation of the present application.

FIG. 6A is a diagram illustrating an exemplary bitmap from a TRP to a UE having beam correspondence capability in a normal speed environment, according to an exemplary implementation of the present application.

FIG. 6B is a diagram illustrating an exemplary bitmap from a TRP to a UE having beam correspondence capability in a high speed environment, according to an exemplary implementation of the present application.

FIG. 6C is a diagram illustrating an exemplary bitmap from a TRP to a UE without having beam correspondence capability, according to an exemplary implementation of the present application.

FIG. 7A is a diagram illustrating procedures for beam acquisition in RRC connected state based on TRP feedback with a bitmap with the UE having beam correspondence capability, according to an exemplary implementation of the present application.

FIGS. 7B(i) and 7B(ii) are a flowchart illustrating one or more actions taken by a UE for beam acquisition in RRC connected state based on TRP feedback with a bitmap with the UE having beam correspondence capability, according to an exemplary implementation of the present application.

FIGS. 7C(i) and 7C(ii) are a flowchart illustrating one or more actions taken by a TRP for beam acquisition in RRC connected state based on TRP feedback with full bitmap with the UE having beam correspondence capability, according to an exemplary implementation of the present application.

FIG. 8A is a diagram illustrating procedures for beam acquisition in RRC_CONNECTED state based on TRP feedback with a single-bit indicator with the UE having beam correspondence capability, according to an exemplary implementation of the present application.

FIG. 8B is a flowchart illustrating one or more actions taken by a UE for beam acquisition in RRC connected state based on TRP feedback with a single-bit indicator with the UE having beam correspondence capability, according to an exemplary implementation of the present application.

FIGS. 8C(i) and 8C(ii) are a flowchart illustrating one or more actions taken by a TRP for beam acquisition RRC connected state based on TRP feedback with a single-bit indicator with the UE having beam correspondence capability, according to an exemplary implementation of the present application.

FIG. 9A is a diagram illustrating procedures for beam acquisition in RRC connected state, based on broadcast information from the TRP with the UE having beam correspondence capability, according to an exemplary implementation of the present application.

FIG. 9B is a flowchart illustrating one or more actions taken by a UE for beam acquisition in RRC connected state, based on broadcast information from the TRP with the UE having beam correspondence capability, according to an exemplary implementation of the present application.

FIG. 9C is a flowchart illustrating one or more actions taken by a TRP for beam acquisition in RRC connected state, based on broadcast information from the TRP with the UE having beam correspondence capability, according to an exemplary implementation of the present application.

FIG. 10 is a block diagram illustrating a radio communication equipment for a cell, in accordance with an exemplary implementation of the present application.

### DETAILED DESCRIPTION

The following description contains specific information pertaining to implementations in the present application. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

For the purpose of consistency and ease of understanding, like features are identified (although, in some examples, not shown) by numerals in the exemplary figures. However, the features in different implementations may be differed in other respects, and thus shall not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent.

Additionally, for the purposes of explanation and non-limitation, specific details, such as functional entities, techniques, protocols, standard, and the like are set forth for providing an understanding of the described technology. In other examples, detailed description of well-known methods, technologies, system, architectures, and the like are omitted so as not to obscure the description with unnecessary details.

Persons skilled in the art will immediately recognize that any network function(s) or algorithm(s) described in the present application may be implemented by hardware, software or a combination of software and hardware. Described functions may correspond to modules may be software, hardware, firmware, or any combination thereof. The software implementation may comprise computer executable instructions stored on computer readable medium such as memory or other type of storage devices. For example, one or more microprocessors or general purpose computers with communication processing capability may be programmed with corresponding executable instructions and carry out the described network function(s) or algorithm(s). The microprocessors or general purpose computers may be formed of applications specific integrated circuitry (ASIC), programmable logic arrays, and/or using one or more digital signal processor (DSPs). Although some of the exemplary implementations described in the present application are oriented to software installed and executing on computer hardware, nevertheless, alternative exemplary implementations implemented as firmware or as hardware or combination of hardware and software are well within the scope of the present application.

The computer readable medium includes but is not limited to random access memory (RAM), read only memory (ROM), erasable programmable read-only memory (EPROM), electrically erasable programmable read-only memory (EEPROM), flash memory, compact disc read-only memory (CD ROM), magnetic cassettes, magnetic tape, magnetic disk storage, or any other equivalent medium capable of storing computer-readable instructions.

The present application provides a method for signaling RAN parameters adopting a RAN profile indexing mechanism to facilitate the transmission and reception operations, where the RAN profile indices correspond to the physical layer compositions between a cell in a radio access network and at least one mobile station (e.g., a UE). By using the indexing mechanism to indicate the RAN profile information, the amount of signaling overhead and latency incurred for RAN profile may be greatly reduced, while supporting the flexibility of NR network system.

A radio communication network architecture (e.g., a long term evolution (LTE) system, a LTE-Advanced (LTE-A) system, or a LTE-Advanced Pro system) typically includes at least one base station, at least one user equipment (UE), and one or more optional network elements that provide connection towards a network. The UE communicates with the network (e.g., a core network (CN), an evolved packet core (EPC) network, an Evolved Universal Terrestrial Radio Access (E-UTRA) network, a Next-Generation Core (NGC), or an internet), through a radio access network (RAN) established by the base station.

It should be noted that, in the present application, a UE may include, but is not limited to, a mobile station, a mobile terminal or device, a user communication radio terminal. For example, a UE may be a portable radio equipment, which includes, but is not limited to, a mobile phone, a tablet, a wearable device, a sensor, or a personal digital assistant (PDA) with wireless communication capability. The UE is configured to receive and transmit signals over an air interface to one or more cells in a radio access network.

A TRP (e.g., HF-TRP or LF-TRP), which is also be regarded as a remote radio head (RRH), may be a transceiver under the protocols of 5G NR wireless communication system and/or the protocols of a 4G wireless communication system. A TRP may be communicatively connected to a base station, which may be, but not limited to, a node B (NB) as in the LTE, an evolved node B (eNB) as in the LTE-A, a radio network controller (RNC) as in the UMTS, a base station controller (BSC) as in the GSM/GERAN, a new radio evolved node B (NR eNB) as in the NR, a next generation node B (gNB) as in the NR, and any other apparatus capable of controlling radio communication and managing radio resources within a cell. The base station may connect to serve the one or more UEs through one or more TRPs in the radio communication system.

A base station may be configured to provide communication services according to at least one of the following radio access technologies (RATs): Worldwide Interoperability for Microwave Access (WiMAX), Global System for Mobile communications (GSM, often referred to as 2G), GSM EDGE radio access Network GERAN), General Packet Radio Service (GRPS), Universal Mobile Telecommunication System (UMTS, often referred to as 3G) based on basic wideband-code division multiple access (W-CDMA), high-speed packet access (HSPA), LTE, LTE-A, New Radio (NR, often referred to as 5G), and/or LTE-A Pro. However, the scope of the present application should not be limited to the above mentioned protocols.

The base station is operable to provide radio coverage to a specific geographical area using a plurality of cells forming the radio access network. The base station supports the operations of the cells. Each cell is operable to provide services to at least one UE within its radio coverage indicated by 3GPP TS 36.300, which is hereby also incorporated by reference. More specifically, each cell (often referred to as a serving cell) provides services to serve one or more UEs within its radio coverage, (e.g., each cell schedules the downlink and optionally uplink resources to at least one UE within its radio coverage for downlink and optionally uplink packet transmissions). The base station can communicate with one or more UEs in the radio communication system through the plurality of cells. A cell may allocate sidelink (SL) resources for supporting proximity service (ProSe). Each cell may have overlapped coverage areas with other cells.

As discussed above, the frame structure for NR is to support flexible configurations for accommodating various next generation (e.g., 5G) communication requirements, such as enhanced mobile broadband (eMBB), massive machine type communication (mMTC), ultra reliable communication and low latency communication (URLLC) more efficiently, while fulfilling high reliability, high data rate and low latency requirements. The orthogonal frequency-division multiplexing (OFDM) technology as agreed in 3GPP may serve as a baseline for NR waveform. The scalable OFDM numerology, such as the adaptive sub-carrier spacing, the channel bandwidth, and the Cyclic Prefix (CP) may be also used. Additionally, three candidate coding schemes are considered for NR: (1) low-density parity-check (LDPC), (2) Polar Code, and (3) Turbo Code. The coding scheme adaption may be configured based on the channel conditions and/or the service applications.

Moreover, it is also considered that in a transmission time interval Tₓ of a single NR frame, a downlink (DL) transmission data, a guard period, and an uplink (UL) transmission data should at least be included, where the respective portions of the DL transmission data, the guard period, the UL transmission data should also be configurable, for example, based on the network dynamics of NR.

In various implementations of the present application, Phase Tracking Reference Signals (PT-RS) and Channel State Information Reference Signals (CSI-RS) are used to monitor channel state information (e.g., channel reciprocity, Doppler shift or Doppler spread), for example, in RRC_CONNECTED state. In various implementations of the present application, Primary Synchronization Signals (PSS) or Secondary Synchronization Signals (SSS) can be used to monitor channel state information, for example, in the initial access has phase.

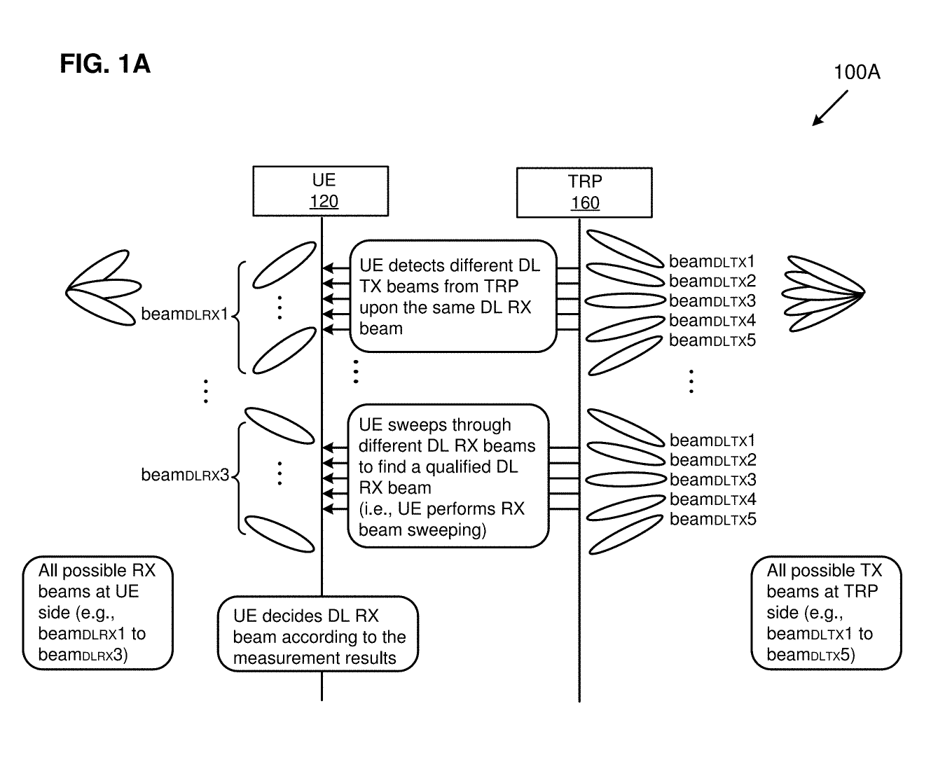

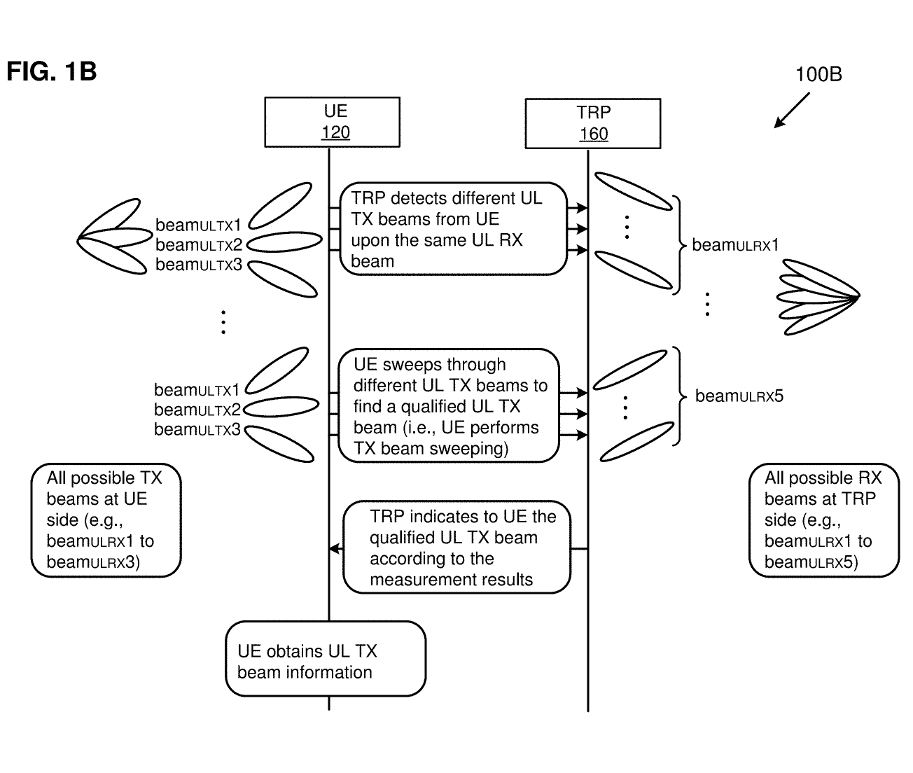

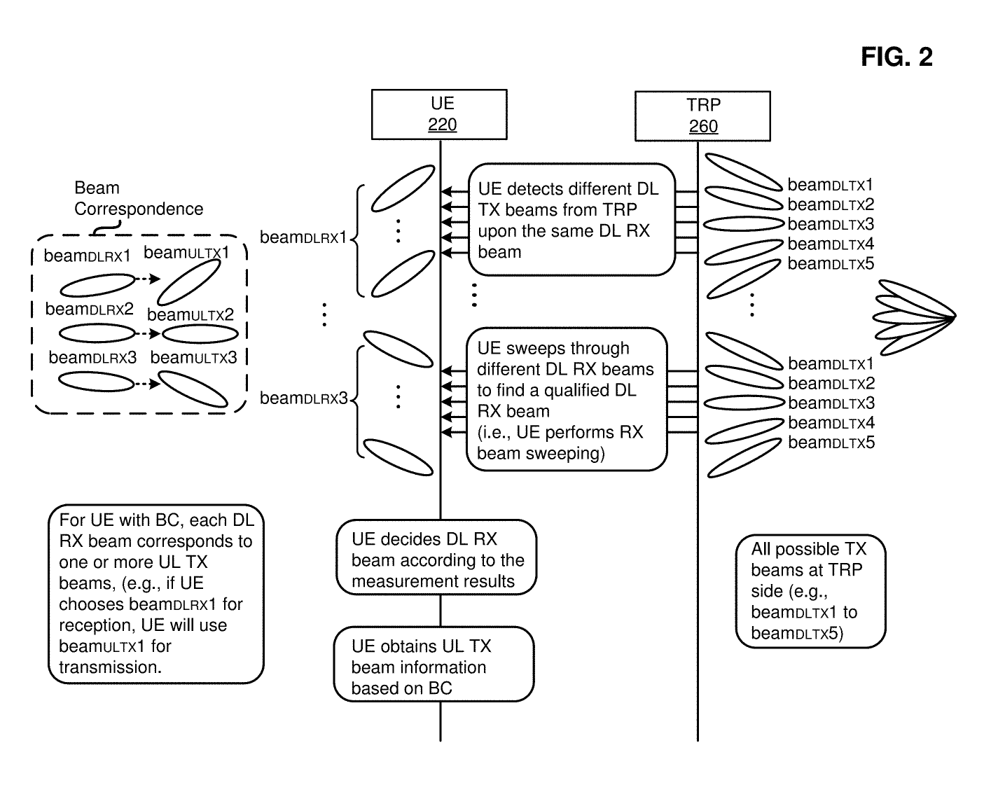

In various implementations of the present application, in addition to the measurement methods of the UE side, the TRP in some environment can broadcast information for the UE to indicate whether the UE with BC needs to monitor the CSI for applying the simplified beam acquisition procedure (e.g., as shown in FIG. 2). For example, if the UE receives the broadcast information which indicates that the UE does not need to monitor CSI, then the UE with BC can apply the simplified beam acquisition procedure directly. In some implementations, such indicator may be broadcast via PBCH, system information, or PDCCH upon different beams. The indicator can be a one-bit indicator, where the bit being set to “1” indicates that the simplified acquisition (as shown in FIG. 1A or 1B) is desirable upon the cell/beam; otherwise, the UE needs to perform the normal beam acquisition procedure (as shown in FIG. 2) even if the UE holds BC.

Implementations of the present application include beam acquisition procedures for UE with BC in both the initial access phase and RRC_CONNECTED state, although the signaling between the TRP and the UE may be different between the initial access phase and RRC_CONNECTED state.

In various implementations of the present application, an initial access phase may include synchronization and/or random access, for example, until a UE receives higher layer configuration of Transmission Configuration Indication (TCI) states and before reception of the activation command. In various implementations of the present application, a connected state may refer to RRC_CONNECTED state.

In various implementations of the present application, when the simplified beam acquisition procedure is applied, the higher layer parameter, SRS-SpatialRelationInfo, is set to “CSI-RS”. The UE may transmit the sounding reference signal (SRS) resource with the same spatial domain transmission filter used for the reception of a periodic CSI-RS or of a semi-persistent CSI-RS. Then, the UE determines its Physical Uplink Shared Channel (PUSCH) transmission precoder (digital or analog) based on SRS resource indicator (SRI). In various implementations of the present application, a UE may apply the simplified beam acquisition procedure based on a bitmap or an indication. Otherwise, when the normal beam acquisition procedure is applied, the UE ignores the SRS-SpatialRelationInfo configured, for example, by the base station until the UE receives one or more SRS resource set for determining new UL beam.

In various implementations of the present application, specific CSI measurements may include CSI type II report. In various implementations of the present application, rough CSI measurements may include all the measurements except CSI type II report.

### Use Case 1—CSI Monitoring in Initial Access Phase with UE Having BC

In various embodiments of the present application, in the initial access phase, a UE may be configured to monitor CSI to improve robustness of beam acquisition based on BC. In various implementations, reference signals (e.g., synchronization signals (PSS, SSS or other SSs), CSI-RS, and PT-RS) may be used by the UE to measure CSI. During the initial access phase, there is RRC signaling such that the UE may not validate channel reciprocity. Thus, in the initial access phase, the UE may monitor rough CSI (e.g., Doppler shift, delay spread or angular spread). Furthermore, since the TX-RX BC of the UE can be transparent to the system and no different signaling procedure is needed for non-BC case than in BC case during the initial access phase as shown in 3GPP NR R1-1701091, the UE does not need to indicate BC capability or CSI to the TRP in the initial access phase. The following show two embodiments for UE to adjust the beam acquisition. The first embodiment shows that the UE can adjust the beam acquisition procedure based on CSI measured by the UE. The second embodiment shows that the UE can adjust the beam acquisition procedure based on the broadcast information from the TRP. Details of the two embodiments in the initial access phase considering BC on the UE side are shown below:

### Use Case 1: Embodiment 1—Based on UE-Measured CSI

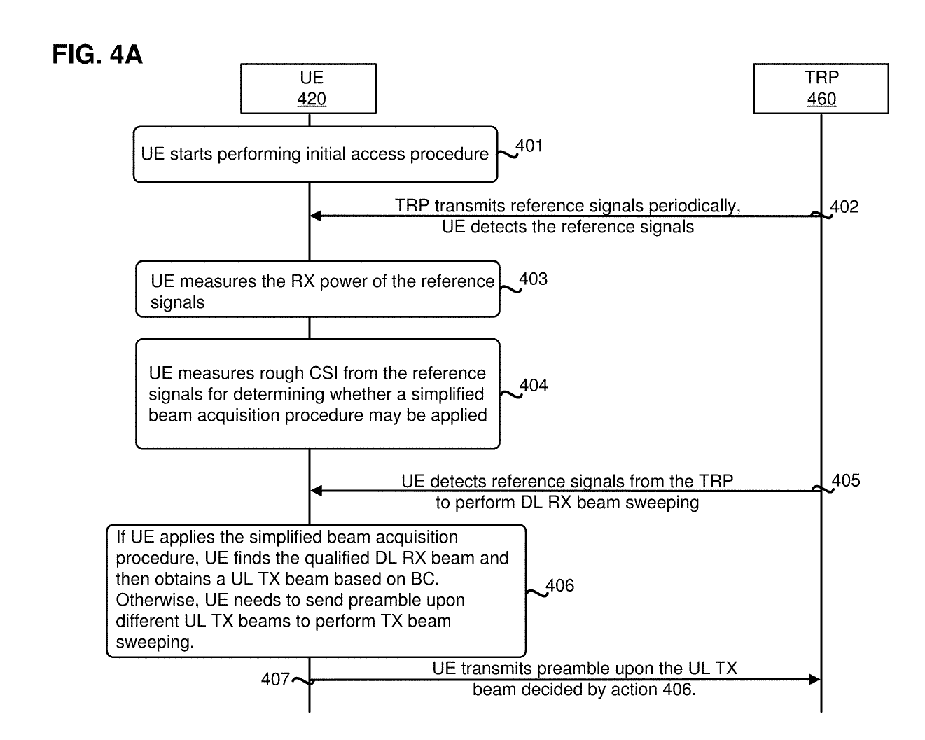

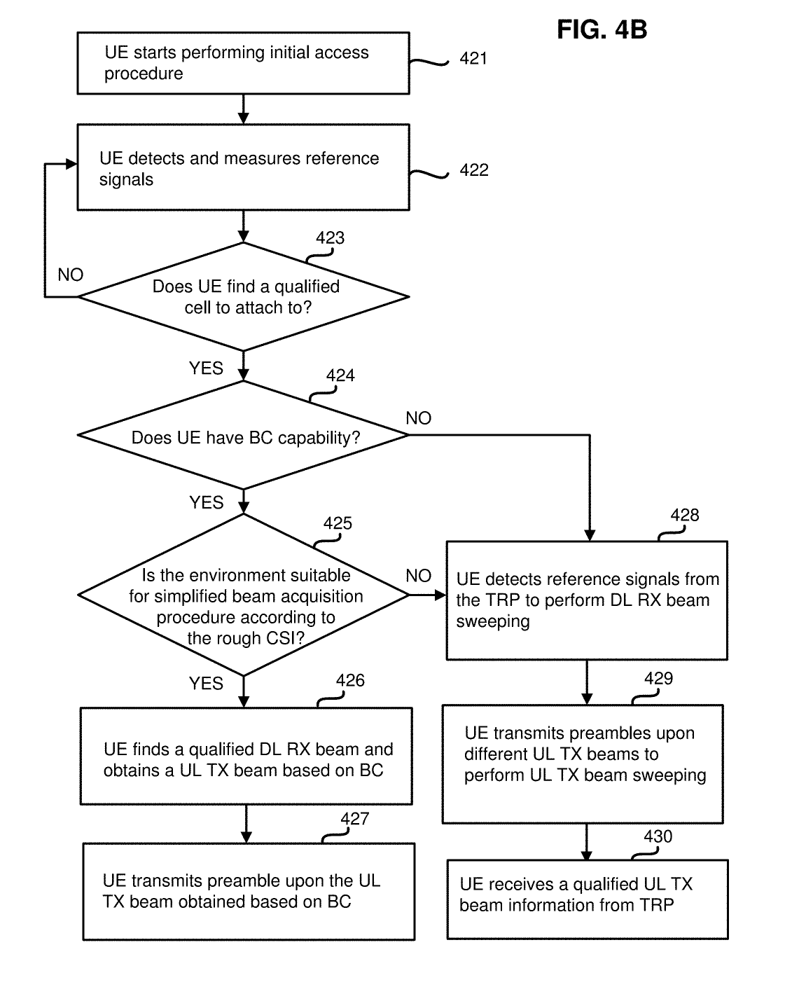

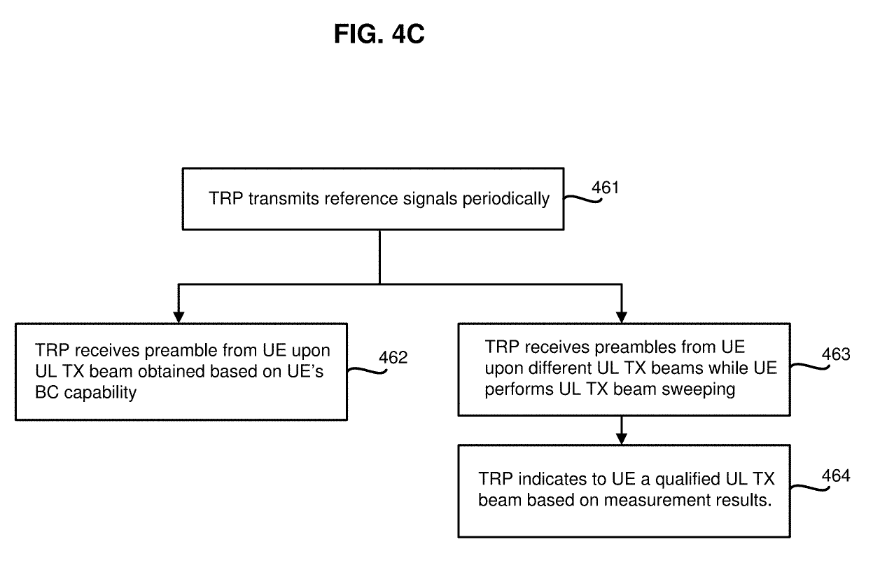

FIG. 4A is a diagram illustrating a beam acquisition procedure based on UE-measured channel state information (CSI) monitoring in an initial access phase with a UE having beam correspondence capability, according to an exemplary implementation of the present application. With reference to FIG. 4A, in action 401, UE 420 starts performing the initial access procedure. In action 402, TRP 460 transmits reference signals synchronization signals (e.g., PSS and SSS), CSI-RS, and PT-RS) periodically, and UE 420 detects the reference signals upon different DL RX beams. In action 403, UE 420 measures the receive power of the reference signals to find a cell/beam to attach to. In action 404, if there are qualified reference signals (e.g., the reference signal received power (RSRP) of reference signals is above the threshold), UE 420 measures the rough CSI from the reference signals (e.g., PSS, SSS or other synchronization signals) for determining whether the simplified beam acquisition procedure (e.g., using beam correspondence to recognize a qualified beam) may be applied. In action 405, UE 420 detects the reference signals from TRP 460, based on the selection in action 404, to perform DL RX beam acquisition if needed. Otherwise, UE 420 may reuse the measurement result from action 402. In action 406, if UE 420 can apply the simplified beam acquisition procedure (i.e., UE 420 holds BC capability and the measurement result of rough CSI supports BC capability), UE 420 may obtain a qualified DL RX beam, and then obtain the corresponding UL TX beam based on BC. Otherwise, UE 420 may need to send a preamble upon different UL TX beams to allow TRP 460 to perform TX beam sweeping to identify a qualified UL TX beam. In action 407, if UE 420 can apply the simplified beam acquisition procedure, UE 420 may transmit a preamble (e.g., MSG 1) to TRP 460 upon the corresponding UL TX beam obtained based on BC in action 406. On the other hand, if UE 420 does not hold BC capability, UE 420 has to perform TX beam acquisition with UL TX beam sweeping while transmitting a preamble (e.g., MSG 1) upon different beams to find a qualified UL TX beam based on the feedback from TRP 460 (e.g., as described in FIG. 1B).

FIG. 4B is a flowchart illustrating one or more actions taken by a UE (e.g., UE 420 FIG. 4A) for beam acquisition based on UE-measured CSI monitoring in an initial access phase with the UE having beam correspondence capability, according to an exemplary implementation of the present application. With reference to FIG. 4B, in action 421, UE 420 starts performing an initial access procedure. In action 422, UE 420 detects and measures the reference signals upon different DL RX beams. In action 423, UE 420 measures the receive power of reference signals to determine if there is a qualified cell/beam to attach to. If the determination of action 423 is No, the flowchart goes back to action 422. If the determination of action 423 is Yes, the flowchart proceeds to action 424, where UE 420 determines whether it has beam correspondence capability. If the determination of action 424 is No, the flowchart proceeds to action 428. If the determination of action 424 is Yes, the flowchart proceeds to action 425. In action 425, UE 420 determines whether the environment is suitable for applying the simplified beam acquisition procedure according to the rough CSI measurements. For example, UE 420 measures the rough CSI from the reference signals (e.g., PSS, SSS, CSI-RS, PT-RS, or other reference signals) to decide whether to use simplified beam acquisition procedure (e.g., using beam correspondence to recognize a qualified beam). If the determination of action 425 is No, the flowchart proceeds to action 428. If the determination of action 425 is Yes, the flowchart proceeds to action 426. In action 426, UE 420 detects the reference signals from TRP 460 to perform DL RX beam sweeping. In action 427, UE 420 transmits a preamble upon the UL TX beam obtained by applying beam correspondence based on the DL RX beam. Otherwise, if UE 420 does not have BC capability, or if the environment is not suitable for the simplified beam acquisition procedure, UE 420, in action 428, may have to detect reference signals from TRP 460 to perform DL RX beam sweeping. In action 429, UE 420 transmits preambles upon different UL TX beams perform UL TX beam sweeping to allow TRP 460 to identify a qualified UL TX beam. In action 430, UE 420 receives a qualified UL TX beam information from TRP 460.

FIG. 4C is a flowchart illustrating one or more actions taken by a TRP (e.g., TRP 460 in FIG. 4A) for beam acquisition based on UE-measured CSI monitoring in an initial access phase with the UE having beam correspondence capability, according to an exemplary implementation of the present application. In FIG. 4C, in action 461, TRP 460 transmits (e.g., broadcast) reference signals periodically. In action 462, TRP 460 receives a preamble from UE 420 upon UL TX beam obtained based on UE's BC capability. Otherwise, if UE 420 does not have BC capability, or if the environment is not suitable for the simplified beam acquisition procedure, in action 463, TRP 460 receives preambles upon different UL TX beams for UE 420 to perform UL TX beam sweeping to identify a qualified UL TX beam. In action 464, TRP 460 indicates to UE 420 a qualified UL TX beam according to the measurement results.

### Use Case 1: Embodiment 2—Based on Broadcast Information from TRP

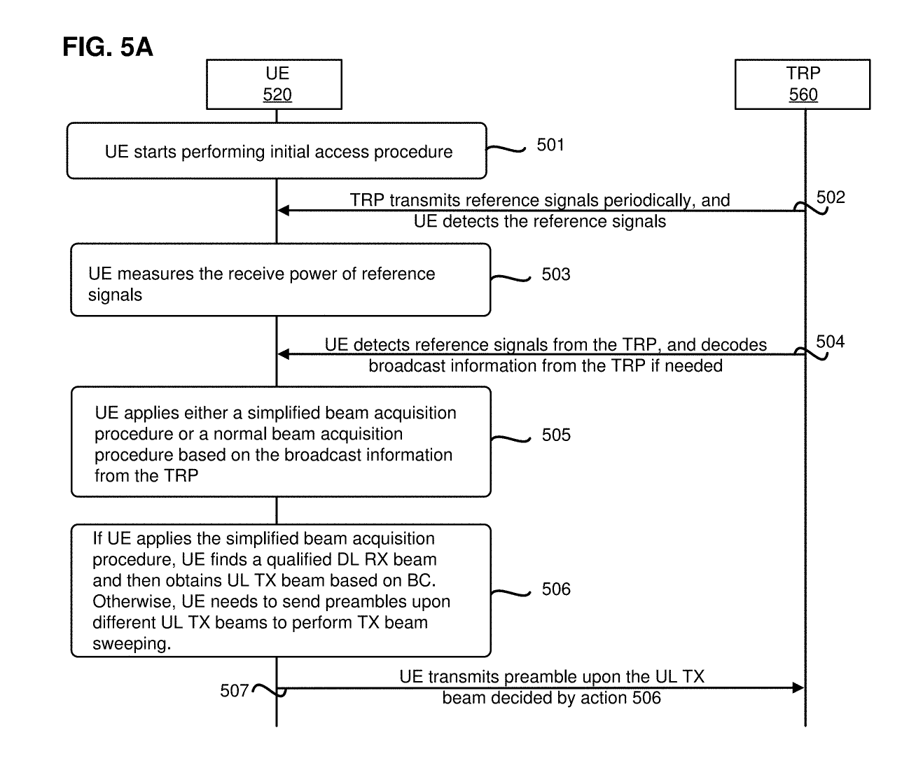

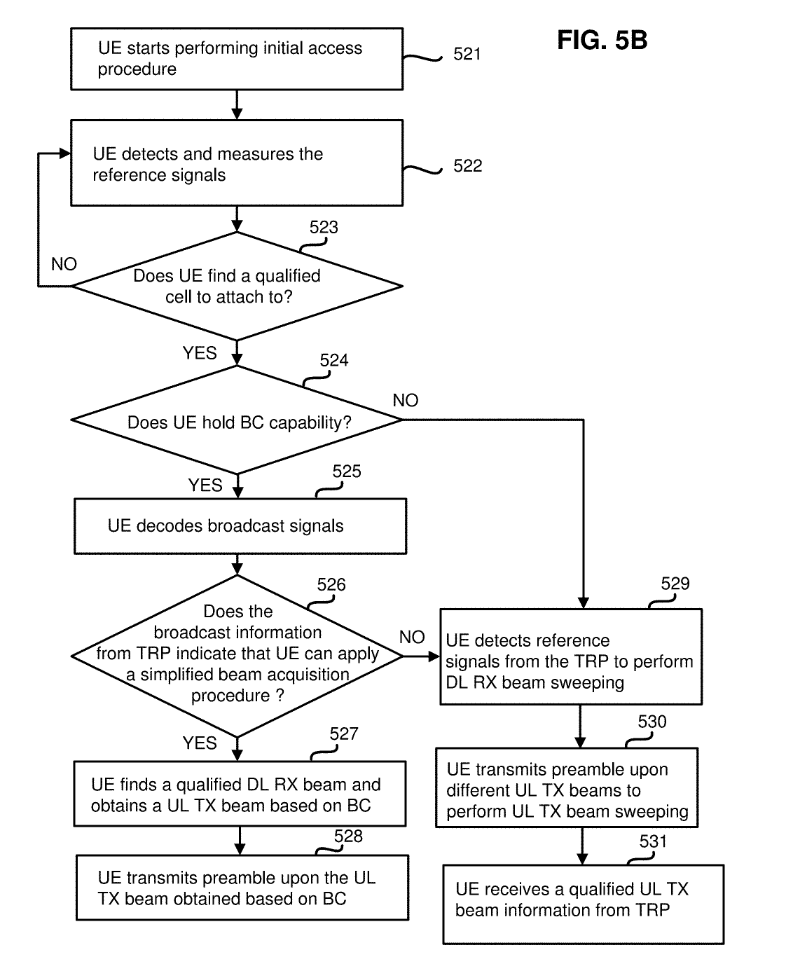

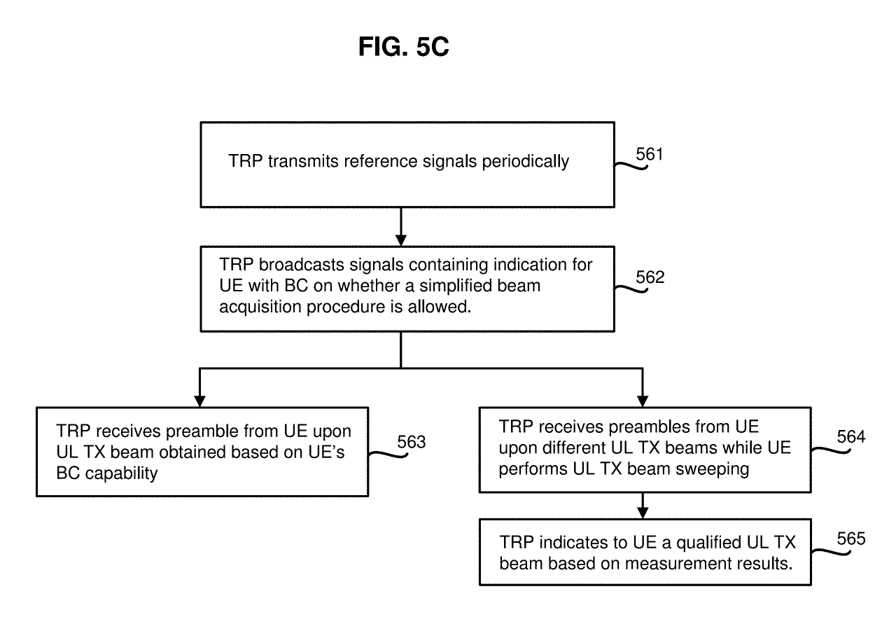

FIG. 5A is a diagram illustrating a beam acquisition procedure based on broadcast information from a TRP in an initial access phase with a UE having beam correspondence capability, according to an exemplary implementation of the present application. With reference to FIG. 5A, in action 501, UE 520 starts performing an initial access procedure. In action 502, TRP 560 transmits reference signals (e.g., synchronization signals (e.g., PSS and SSS), CSI-RS, and PT-RS) periodically, and UE 520 detects the reference signals upon different DL RX beams. In action 503, UE 520 measures the receive power of reference signals to find a cell/beam to attach to. UE 520 detects the reference signals from TRP 560, selected in action 502, to perform DL RX beam acquisition if needed, or UE 520 may reuse the measurement result of action 502. UE 520 may decode the broadcast information based on the broadcasted signals obtained from the indication of the reference signals. In action 505, UE 520 applies either the simplified beam acquisition procedure or the normal beam acquisition procedure based on the broadcast information from TRP 560. UE 520 may check an indicator in the broadcast information to see whether the one-bit indicator is set to “1” (e.g., “True”). If the indicator is “1”, then it indicates that the simplified acquisition is desirable upon this cell/beam, thus, UE 520 may apply the simplified acquisition procedure. If the indicator is “0”, then it indicates that the normal acquisition is desirable upon this cell/beam, thus, UE 520 may apply the normal acquisition procedure. In action 506, if UE 520 can apply simplified beam acquisition procedure, (e.g., UE 520 holds BC capability and/or the broadcast information indicate that UE 520 with BC may apply simplified procedure), UE 520 finds a qualified DL RX beam, then obtains the corresponding UL TX beam based on BC. Otherwise, UE 520 may need to send preambles upon different UL TX beams to allow TRP 560 to identify a qualified UL TX beam. In action 507, if UE 520 can apply the simplified beam acquisition procedure, UE 520 may transmit a preamble (e.g., MSG 1) upon the corresponding UL TX beam obtained based on BC. On the other hand, if UE 520 does not have BC capability, or if TRP 560 indicates no simplified beam acquisition is allowed in its coverage, UE 520 may need to perform TX beam acquisition with UL TX beam sweeping while transmitting a preamble (e.g., MSG 1) upon different beams, and obtains a qualified UL TX beam based on the feedback from TRP 560.

FIG. 5B is a flowchart illustrating one or more actions taken by a UE (e.g., UE 520 in FIG. 5A) for beam acquisition based on broadcast information from a TRP in an initial access phase with the UE having beam correspondence capability, according to an exemplary implementation of the present application. With reference to FIG. 5B, in action 521, UE 520 starts performing an initial access procedure. In action 522, UE 520 detects and measures the reference signals upon different DL RX beams. In action 523, UE 520 measures the receive power of reference signals to determine if there is a qualified cell/beam to attach to. If the determination of action 523 is No, the flowchart goes back to action 522. If the determination of action 523 is Yes, the flowchart proceeds to action 524, where the UE 520 determines whether it has beam correspondence capability. If the determination of action 524 is No, the flowchart proceeds to action 529. If the determination of action 524 is Yes, the flowchart proceeds to action 525, where UE 520 decodes broadcast signals from TRP 560. In action 526, UE 520 determines whether the broadcast signals from TRP 560 indicate that UE 520 can apply the simplified beam acquisition procedure. If the determination of action 526 No, the flowchart proceeds to action 529. If the determination of action 526 is Yes, the flowchart proceeds to action 527. In action 527, UE 520 detects the synchronization signals from TRP 560 to perform DL RX beam sweeping. In action 528, UE 520 transmits a preamble upon the UL TX beam obtained by applying beam correspondence based on the DL RX beam. Otherwise, if UE 520 does not have BC capability, or if the broadcast signals from TRP 560 indicate that UE 520 is not allowed to apply the simplified beam acquisition procedure, UE 520, in action 529, may need to detect synchronization signals from TRP 560 to perform DL RX beam sweeping. In action 530, UE transmits a preamble upon different UL TX beams perform UL TX beam sweeping to allow TRP 560 to identify a qualified UL TX beam. In action 531, UE 520 receives a qualified UL TX beam information from TRP 560.

FIG. 5C is a flowchart illustrating one or more actions taken by a TRP (e.g., TRP 560 in FIG. 5A) for beam acquisition based on broadcast information from the TRP in an initial access phase with the UE having beam correspondence capability, according to an exemplary implementation of the present application. In FIG. 5C, in action 561, TRP 560 transmits (e.g., broadcast) reference signals periodically. In action 562, TRP 560 broadcasts signals containing indication for UE with BC on whether the simplified beam acquisition procedure is allowed. In action 563, TRP 560 receives a preamble from UE 520 upon UL TX beam obtained based on UE's BC capability. Otherwise, if UE 520 does not have BC capability, or if the broadcast signals indicate that the simplified beam acquisition procedure is not allowed, in action 564, TRP 560 receives preambles upon different UL TX beams for UE 520 to perform UL TX beam sweeping to identify a qualified UL TX beam. In action 565, TRP 560 indicates to UE 520 a qualified UL TX beam according to the measurement results.

### Use Case 2—CSI Monitoring in RRC_CONNECTED State with UE Having BC

In various embodiments of the present application, in RRC_CONNECTED state, a UE may need to perform beam management (e.g., beam acquisition or beam report) to maintain transmission quality (e.g., reference signal received power (RSRP)). The BC capability of a UE can also be used to simplify the beam acquisition procedure similar to that in the initial access phase. Because the UE and the TRP can exchange signaling in connected phase, the UE may send a BC indication to the TRP (e.g., through RRC signaling) to simplify the beam acquisition procedure. As mentioned before, to improve the robustness of beam acquisition based on beam correspondence, the UE may need to monitor CSI. In RRC_CONNECTED state, the TRP may use PT-RS or CSI-RS to aid the UE in monitoring CSI for beam acquisition. In RRC_CONNECTED state, CSI comprises at least one of rough CSI (e.g., Doppler shift, delay spread or angular spread) and Channel Reciprocity (CR) verification, where CR indicates that the UL channel matrix is the inverse of the DL channel matrix. Thus, the UE may obtain a qualified UL TX beam through DL signal measurements. A valid CR can also be used to reduce overhead during the beam acquisition procedure. The difference between CR and BC may include that BC is a capability of hardware device, while CR is based on the measurement results of the transmission environment. Hence, while the UE holds CR, even though the UE without BC, it can simplify the beam acquisition procedure. For example, validating the CR allows the UE to know whether it can apply simplified beam acquisition. In comparison, a UE with BC does not need to validate CR because the UE can obtain a qualified beam by its BC capability (e.g., obtain UL TX beam information by DL RX beam information) if the environment is suitable for BC. In one implementation, a UL TX beam may be obtained through quasi-colocation (QCL) information configured in RRC signaling, for example, using SRS resource—QC-information (SRS-SpatialRelationInfo): CSI-RS resource. In another implementation, a DL RX beam may be obtained through QCL information configured in RRC signaling, for example, using CSI resource—QCL information: SRS-RS resource. To determine whether the environment around the UE suitable for BC, the UE may send feedback of a rough CSI measurement report to the TRP. The TRP may send an indication to the UE of whether the environment is suitable for BC based on the measurement report. For example, if applying BC would not lead to a qualified beam (e.g. RSRP falls below a threshold) in an environment (e.g., high speed railway or dense urban area), then the TRP may indicate to the UE that the environment is not suitable for applying BC. Otherwise, the UE with BC may simplify the beam acquisition procedure by monitoring the rough CSI (e.g., Doppler shift, delay spread or angular spread). In some implementations, the gNB may have knowledge of the environment in which it is serving. Thus, the gNB may determine whether the UE is traveling at high speed or not, based on, for example, the beam switching history of previously served UEs.

In some implementations, a UE with BC may send feedback to a TRP of a rough CSI measurement result based on monitoring reference signals (e.g., CSI-RS or PT-RS) in order to determine an appropriate beam acquisition procedure (e.g., simplified or normal beam acquisition procedure). Since the rough CSI are based on environmental factors, using different beams for transmission or reception does not affect the measurement result of the rough CSI. That is, if the UE with BC passes the verification of the rough CSI with an arbitrary beam, then the UE may assume that the BC is robust enough for all beams in a configurable period, and does not need to verify CR.

In some implementations, a UE without BC may send feedback of specific CSI (e.g., Type II CSI) measurement results (e.g., channel matrix or eigen vector) to the TRP in order to check for or verify CR. Furthermore, different from the BC, CR depends on specific CSI so that the measurement results of CR may be different among all possible DL RX beams. After the TRP receives the specific CSI measurement report(s), the TRP may determine whether each DL RX beam that the UE uses to receive DL signals can hold/apply CR e.g., the UL channel matrix matches the inverse of the DL channel matrix) or not. For the DL RX beams that the UE has not measured, the default state of CR may be not available (e.g., the feedback of the DL RX beam is “False”). The UE without BC needs to pass CR verification before applying the simplified beam acquisition procedure to find a new and/or qualified UL TX beam (i.e., the bitmap of the DL RX beam needs to be “True” when the UE tries to obtain a qualified UL TX beam based on the DL RX beam). Moreover, the UE may need to follow the bitmap before performing the UL TX beam acquisition, even when the UE does not change the DL TX beam.

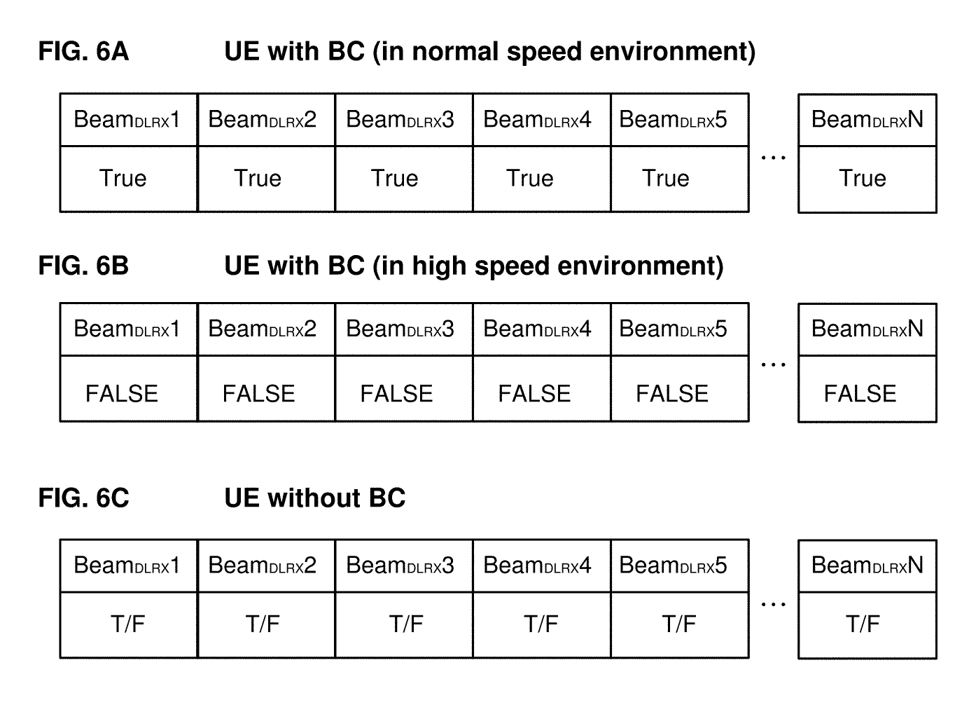

In some implementations, the signaling of BC between the UE and the TRP may include a static one-bit indicator (e.g., it relies on UE capability), and may be indicated by RRC signaling. The signaling of CR between the UE and the TRP may be capable of dynamic/immediate feedback (e.g., CR is a variable based on different environment and different beams). Thus, a bitmap format via MAC-CE (Medium Access Control-Control Element) may be used to indicate the CR verification status of all DL RX beams that UE has already measured and reported the measurement results to the TRP. It should be noted that the default state for the DL RX beam that UE has not measured is “False”. The information field in the bitmap is shown in FIGS. 6A, 6B, and 6C. The bitmap lists fill DL RX beams of the UE, and uses respective bit to represent whether or not each beam passes CR verification (e.g., “True” means pass). In some implementations, the bitmap may list all the configured TCI-states that the TRP uses to indicate one or more DL RX beams for the UE. Each TCI-state is associated with one or more TCI-RS sets, and the UE can obtain the corresponding DL RX beam(s) by QCL-spatial-information of each TCI-RS set. In some implementations, the bitmap is generated based on the measurement reports of reference signals transmitted from the TRP to the UE (e.g., CSI-RS or PT-RS).

FIG. 6A is a diagram illustrating an exemplary bitmap from a TRP to a UE having beam correspondence capability in a normal speed environment, according to an exemplary implementation of the present application. FIG. 6B is a diagram illustrating an exemplary bitmap from a TRP to a UE having beam correspondence capability in a high speed environment, according to an exemplary implementation of the present application. For a UE with BC, the UE may only need to send feedback of rough CSI to the TRP to check whether the environment is suitable for BC. Thus, for UEs with BC, the bitmap may be “True” for all DL RX beams when the environment is suitable for BC (e.g., as shown in FIG. 6A), or all “False” when the environment is not suitable for BC (e.g., as shown in FIG. 6B).

On the other hand, for UEs without BC, the UEs may have to send feedback of specific CSI of each of the DL RX beams. FIG. 6C is a diagram illustrating an exemplary bitmap from a TRP to a UE without having beam correspondence capability, according to an exemplary implementation of the present application. For UEs without BC, each DL RX beam may be indicated independently based on the specific CSI measurements (e.g., as shown in FIG. 6C). That is, the bitmap is depended on whether the transmission channel of each DL RX beam holds CR or not.

The following show three embodiments for CR signaling between a UE with BC and a TRP. In the first embodiment, the TRP may send feedback of a full bitmap with CR verification status of all possible beams to the UE with BC. In the first embodiment, the TRP may only send feedback of a single bit to indicate CR verification for all possible beams to the UE with BC. In the third embodiment, the TRP may send information by broadcast signals to indicate to UEs with BC that they can apply the simplified beam acquisition procedure without monitoring the rough CSI. The UE and the TRP may adjust the beam acquisition procedure for robustness according to the bitmap or the single bit. The details of the signaling procedures will be discussed below in the following sections.

It should be noted that, when the corresponding RS set indicated in the CSI-RS resource in the MAC-CE is turned off, then the SRS resource associated with the CSI-RS resource indicated in the MAC-CE may indicate that the normal UL TX beam acquisition procedure is needed.

### Use Case 2: Embodiment 1—TRP Feedback with Full Bitmap (When UE Holds BC)

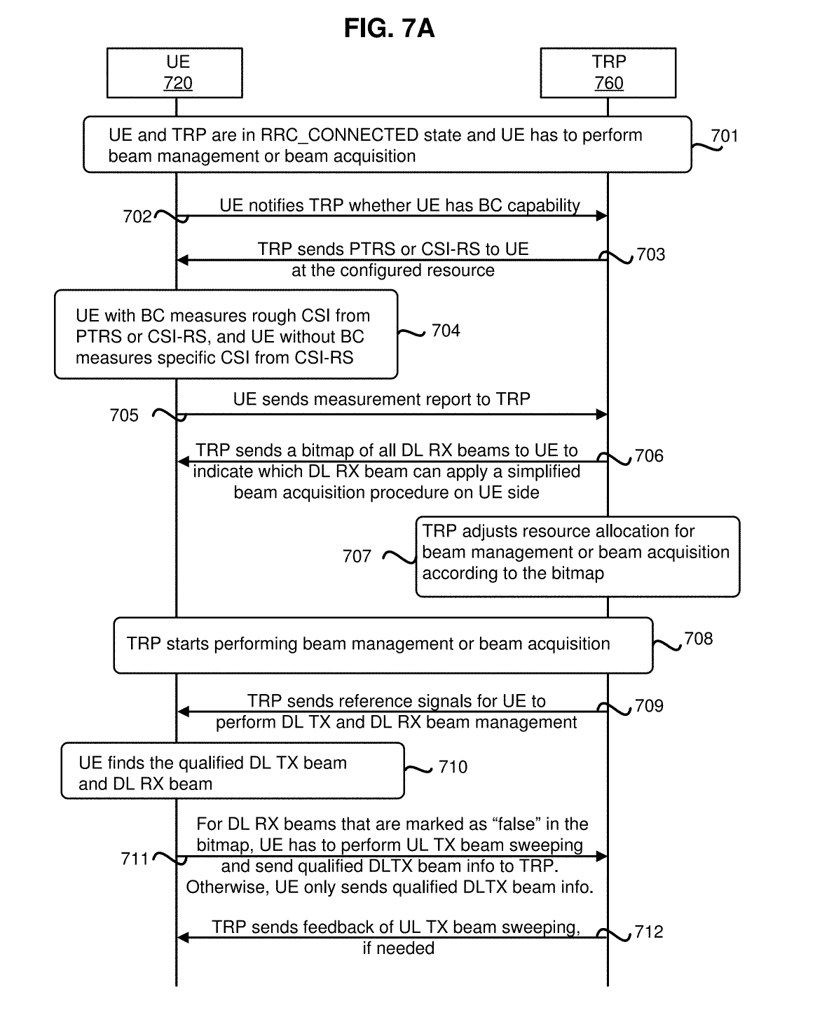

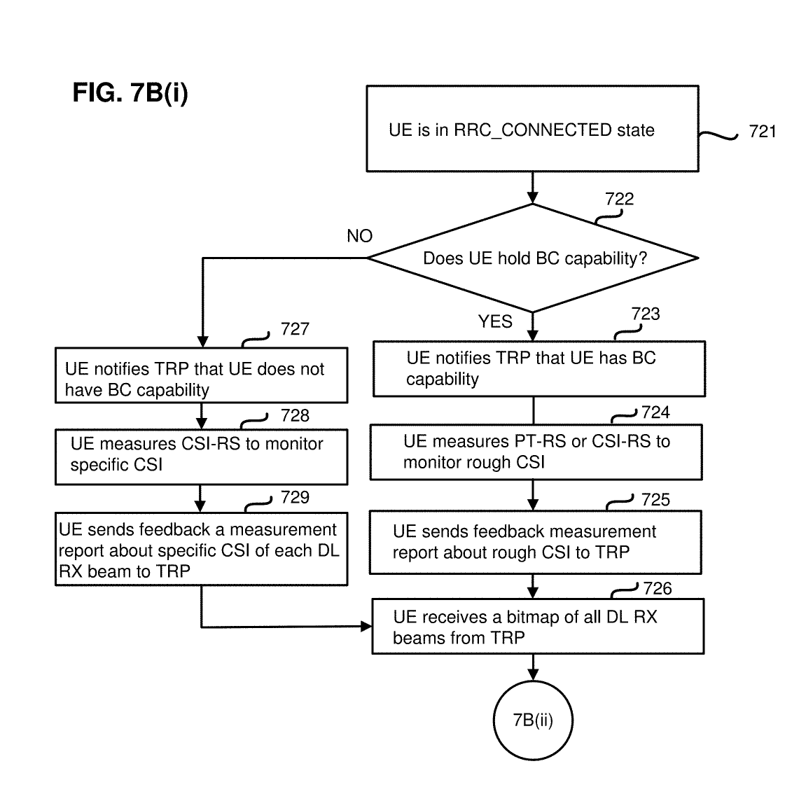

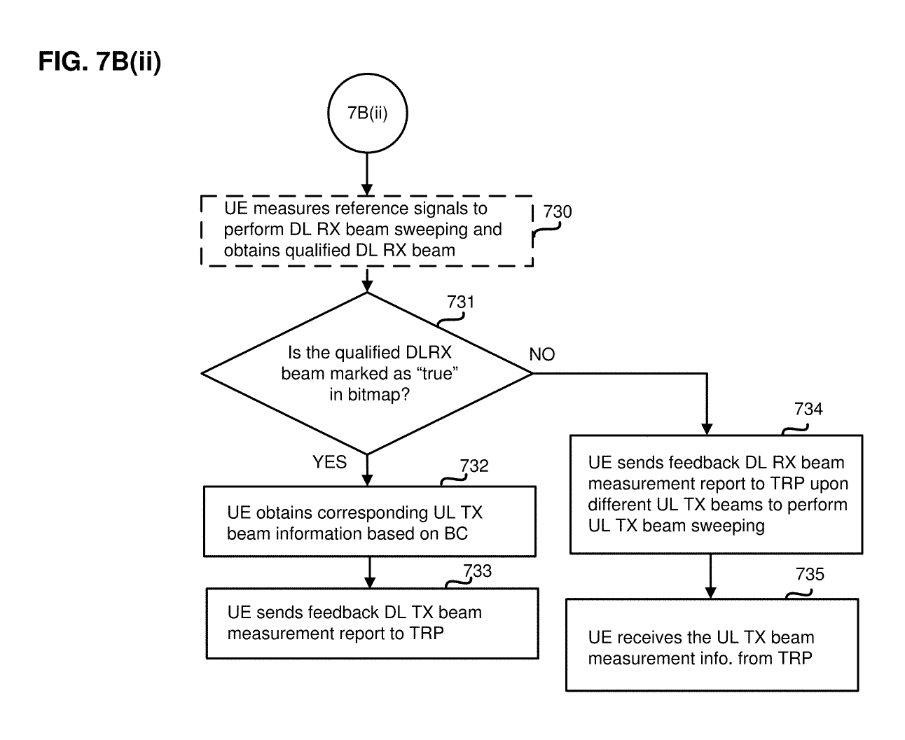

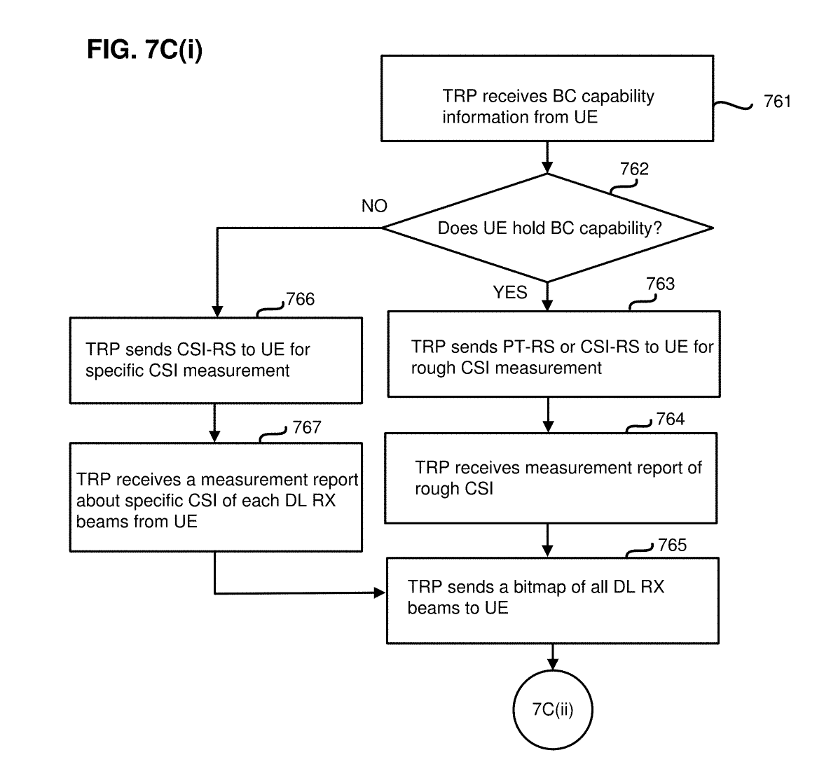

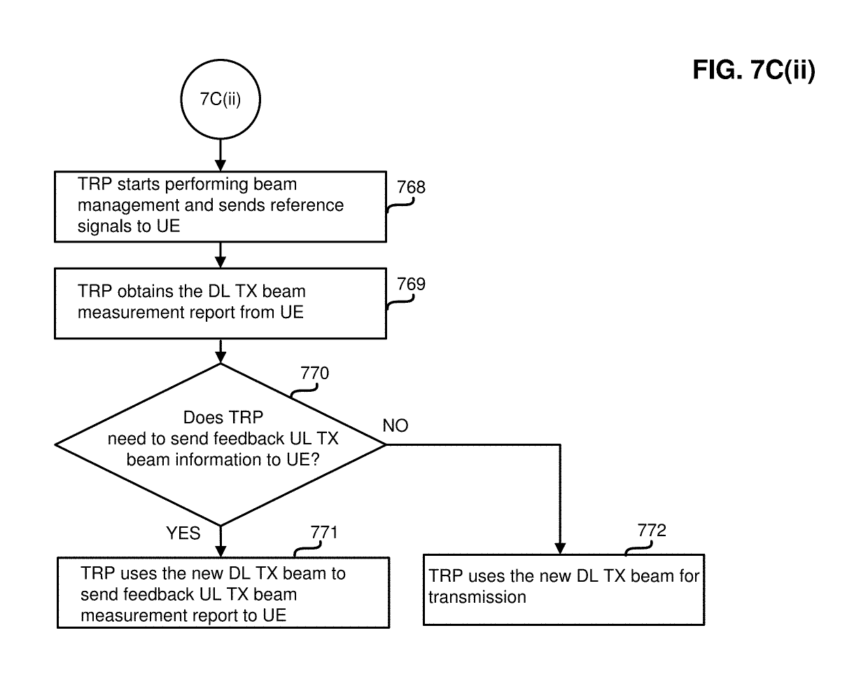

FIG. 7A is a diagram illustrating procedures for beam acquisition RRC connected state based on TRP feedback with a bitmap with the UE having beam correspondence capability, according to an exemplary implementation of the present application. With reference to FIG. 7A, in action 701, UE 720 and TRP 760 are in RRC_CONNECTED state, and UE 720 may need to perform beam management or beam acquisition to maintain the link quality, for example. In action 702, UE 720 notifies TRP 760 whether UE 720 has BC capability or not by RRC signaling. In action 703, TRP 760 configures reference signals (e.g., PT-RS or CSI-RS) to UE 720 at the dedicated/configured resource. The reference signals may be UE-specific, cell-specific or beam-specific. In action 704, UE 720, if with BC, measures the rough CSI (e.g., Doppler shift, delay spread or angular spread) from the reference signals; UE 720, if without BC, measures the specific CSI (e.g., channel matrix or eigen vector) from the reference signals. In action 705, UE 720 sends the measurement report to TRP 760. In action 706, TRP 760 sends a bitmap to UE 720 to indicate which DL RX beam(s) can be used to apply the simplified beam acquisition procedure on UE 720 side. If UE 720 has BC capability, the bitmap may be determined by the rough CSI measurement report from UE 720. If UE 720 does not have BC capability, the bitmap may be determined by the specific CSI measurement report of each of the DL RX beams from UE 720. In the case where UE 720 does not have BC capability, the DL RX beams that have not been measured yet may be marked as “False” in the bitmap. In action 707, TRP 760 adjusts resource allocation for beam management of beam acquisition according to the bitmap. In action 708, TRP 760 starts performing beam management or beam acquisition to maintain the link quality. In action 709, TRP 760 sends reference signals (e.g., CSI-RS or PT-RS) for UE 720 to perform DL TX and DL RX beam management. In action 710, UE 720 finds qualified DL TX beam and DL RX beam after measuring different DL TX beams. In action 711, after obtaining a qualified DL RX beam, UE 720 may need to obtain a qualified UL TX beam. For each of the DL RX beams that represents “False” in the bitmap, UE 720 may need to perform UL TX beam acquisition with UL TX beam sweeping and send qualified DL TX beam information to TRP 760. On the other hand, for each of the DL RX beams that represents “True” in the bitmap, UE 720 can obtain the qualified UL TX beam based on BC capability. Therefore, UE 720 may only need to send the qualified DL TX beam information to TRP 760. In action 712, TRP 760 may indicate the qualified UL TX beam information to UE 720 if UE 720 performs the UL TX beam acquisition with UL TX beam sweeping. If UE 720 does not perform UL TX beam sweeping (e.g., UE 720 obtains a UL TX beam based on BC capability), TRP 760 may only need to receive the DL TX measurement report and apply the new DL TX beam accordingly.

FIGS. 7B(i) and 7B(ii) are a flowchart illustrating one or more actions taken by a UE for beam acquisition in RRC connected state based on TRP feedback with a bitmap with the UE having beam correspondence capability, according to an exemplary implementation of the present application. With reference to FIGS. 7B(i) and 7B(ii), in action 721, UE 720 and TRP 760 are in RRC_CONNECTED state. UE 720 may need to perform beam management or beam acquisition to maintain the link quality. In action 722, UE 720 determines whether it has beam correspondence capability. If the determination of action 722 is Yes, the flowchart proceeds to action 723, where UE 720 notifies TRP 760 that it has beam correspondence capability. In action 724, UE 720 measures/monitors the rough CSI (e.g., Doppler shift, delay spread or angular spread) based on the reference signals from TRP 760. In action 725, UE 720 sends the rough CSI measurement report to TRP 760. In action 726, UE 720 receives a bitmap from TRP 760, where the bitmap is for all DL RX beams from TRP 760.

If the determination of action 722 is No, the flowchart proceeds to action 727, where UE 720 notifies TRP 760 that it does not have beam correspondence capability. In action 728, UE 720 measures the specific CSI (e.g., channel matrix or eigen vector) based on the reference signals from TRP 760. In action 729, UE 720 sends the specific CSI measurement report to TRP 760, where the specific CSI measurement report includes measurements of each of the DL RX beams to TRP 760. After action 729, the flowchart also proceeds to action 726, where UE 720 receives a bitmap fro TRP 760, and the bitmap for all DL RX beams from TRP 760.

In action 730, UE 720 may measure reference signals to perform DL RX beam sweeping to obtain a qualified DL RX beam. In some implementations, action 730 may be optional as illustrated by the dashed lines. In action 731, UE 720 determines whether any of the qualified DL RX beams is marked as “True” in the bitmap from TRP 760. If the determination of action 731 is Yes, the flowchart proceeds to action 732, where UE 720 obtains the corresponding UL TX beam information based on BC. In action 733, UE 720 sends feedback of DL TX beam measurement report to TRP 760. If the determination of action 731 is No, the flowchart proceeds from action 731 to action 734, where UE 720 sends feedback of DL TX beam measurement report to TRP 760 upon different UL TX beams to perform UL TX beam sweeping. In action 735, UE receives the UL TX beam measurement information from TRP which may include qualified UL TX beam information.

FIGS. 7C(i) and 7C(ii) are a flowchart illustrating one or more actions taken by a TRP for beam acquisition in RRC connected state based on TRP feedback with full bitmap with the UE having beam correspondence capability, according to an exemplary implementation of the present application. With reference to FIGS. 7C(i) and 7C(ii), in action 761, TRP 760 receives BC capability information from UE 720. In action 762, TRP 760 determines if UE 720 has beam correspondence capability. If the determination of action 762 is Yes, the flowchart proceeds to action 763, where TRP 760 sends reference signals (e.g., PT-RS or CSI-RS) to UE 720 for rough CSI measurement. In action 764, TRP 760 receives a rough CSI measurement report from UE 720. In action 765, TRP 760 sends a bitmap to UE 720, where the bitmap is for all DL RX beams from TRP 760.

If the determination of action 762 is No, the flowchart proceeds to action 766, where TRP 760 sends CSI-RS to UE 720 for specific CSI measurement. In action 767, TRP 760 receives a specific CSI measurement report from UE 720. After action 767, the flowchart also proceeds to action 765, where TRP 760 sends a bitmap to UE 720, where the bitmap is for all DL RX beams from TRP 760.

In action 768, TRP 720 starts performing beam management and sends reference signals to UE 720. In action 769, TRP 760 obtains the DL TX beam measurement report from UE 720. In action 770, TRP 760 determines whether it needs to send feedback of UL TX beam information to UE 720. If the determination of action 770 is Yes, the flowchart proceeds to action 771, where TRP 760 uses the new DL TX beam to send feedback of the UL TX beam measurement report to UE 720. If the determination of action 770 is No, the flowchart proceeds to action 772, where TRP 760 uses the new DL TX beam for transmission.

### Use Case 2: Embodiment 2—TRP Feedback With a Single Bit (When UE Holds BC)

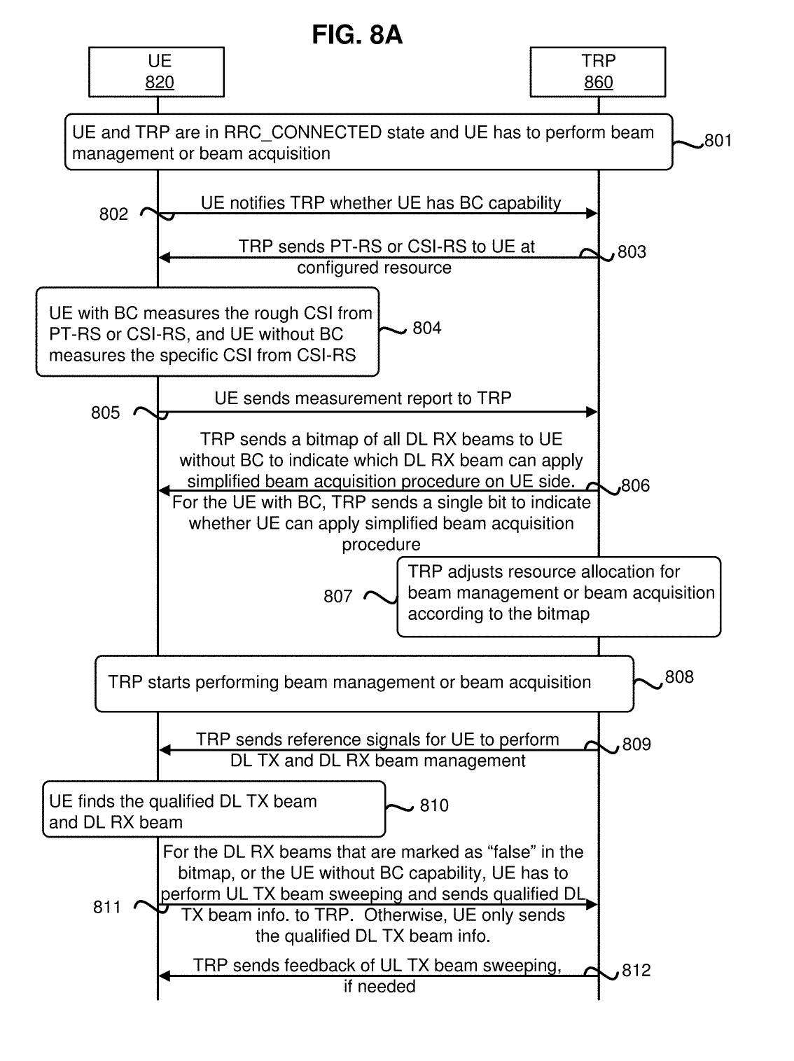

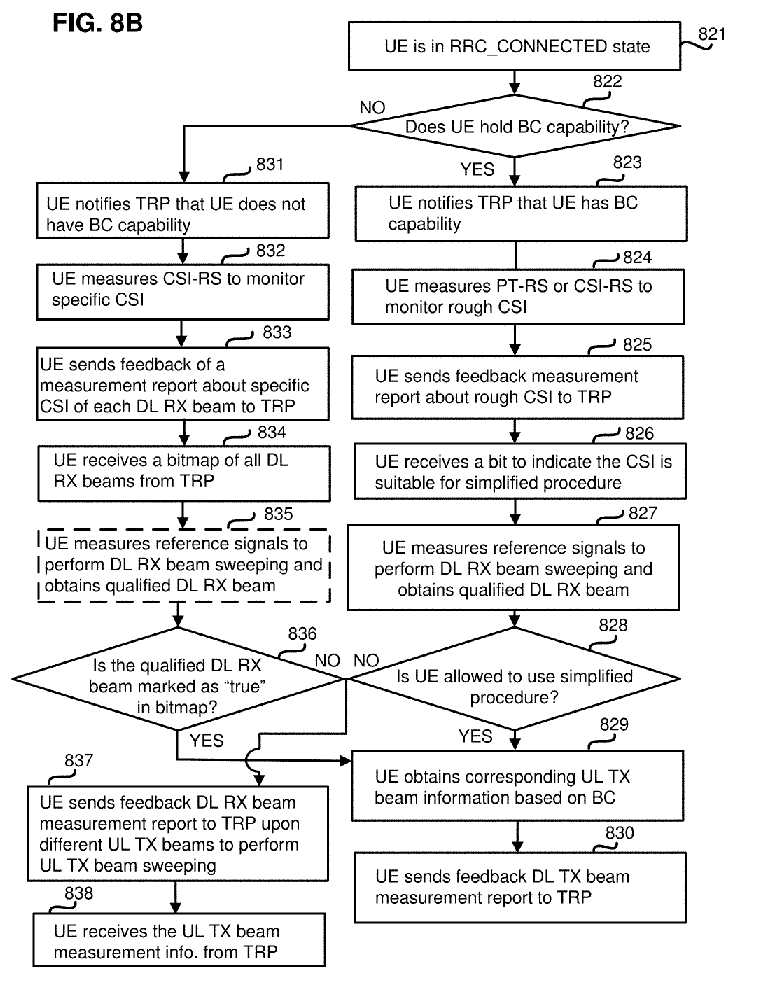

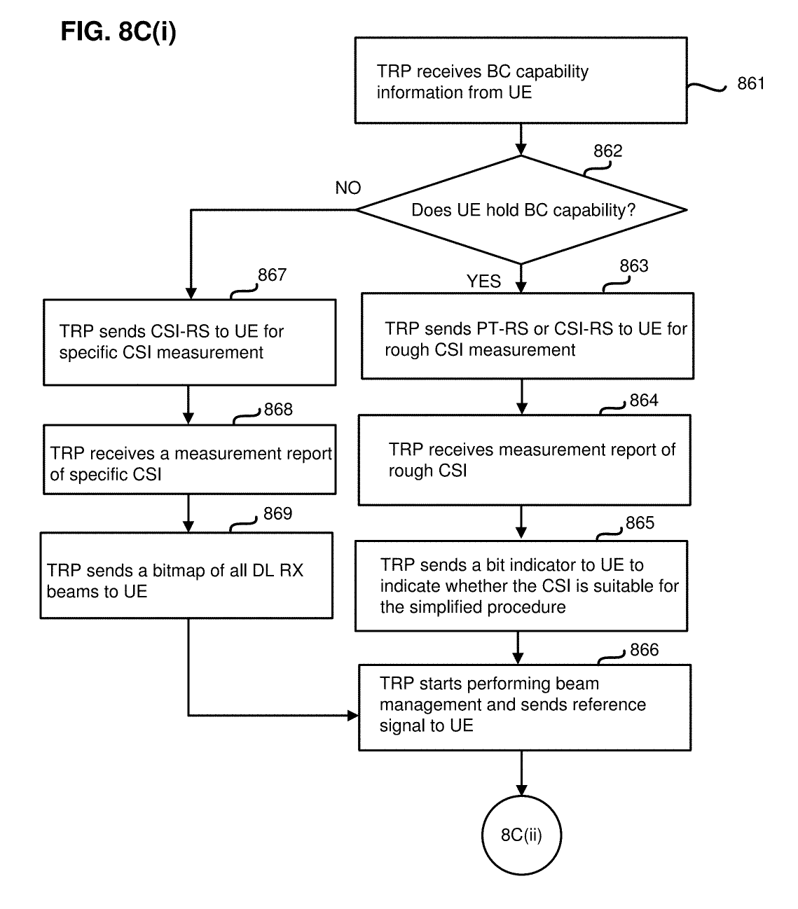

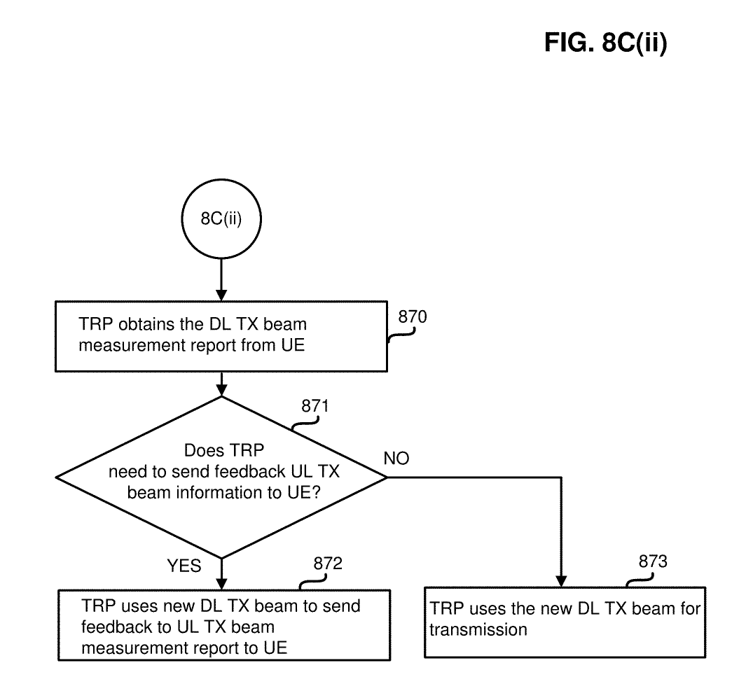

FIG. 8A is a diagram illustrating procedures for beam acquisition in RRC_CONNECTED state based on TRP feedback with a single-bit indicator with the UE having beam correspondence capability, according to an exemplary implementation of the present application. With reference to FIG. 8A, in action 801, UE 820 and TRP 860 are in RRC connected state and UE 820 may need to perform beam management or beam acquisition to maintain the link quality. In action 802, UE 820 notifies TRP 860 whether UE 820 has BC capability by RRC signaling. In action 803, TRP 860 configures reference signals (e.g., PTRS or CSI-RS) to UE 820 at dedicated/configured resource. The reference signals may be UE-specific, cell-specific or beam-specific. In action 804, UE 820, if with BC, may measure the rough CSI (e.g., Doppler shift, delay spread or angular spread) from the reference signals; UE 820, if without BC, may measure the specific CSI (e.g., channel matrix or eigen vector) from the reference signals. In action 805, UE 820 may send the measurement report to TRP 860. In action 806, TRP 860 sends a bitmap or a single bit to UE 820 to indicate whether UE 820 can apply the simplified beam acquisition procedure. If UE 820 holds the BC capability, TRP 860 may only send a single bit to indicate whether UE 820 can apply simplified beam acquisition procedure. For example, if TRP 860 sends “True” (e.g. the bit set to “1”) to UE 820, UE 820 can apply the simplified beam acquisition procedure for all DL RX beams, and vice versa. If UE 820 does not hold the BC capability, the bitmap may be determined by the specific CSI measurement report of each of the DL RX beams from UE 820. In the case that UE 820 does not hold the BC capability, the DL RX beams that have not been measured yet may be marked as “False” in the bitmap (e.g. the bit set to “0”). In action 807, TRP 860 adjusts resource allocation for beam management or beam acquisition according to the bitmap. In action 808, TRP 860 starts performing beam management or beam acquisition to maintain the link quality. In action 809, TRP 860 transmits reference signals (e.g., CSI-RS or PT-RS) for UE 820 to perform DL TX and DL RX beam management. In action 810, UE 820 finds the qualified DL TX beam and DL RX beam after measuring different DL TX beams. In action 811, after obtaining a qualified DL RX beam, UE 820 with BC can obtain the corresponding qualified UL TX beam based on the BC capability. Thus, UE 820 may only need to indicate the qualified DL TX beam information to TRP 860. On the other hand, UE 820 without BC may have to check the bitmap. For the DL RX beam that represents “False” in the bitmap, UE 820 may have to perform UL TX beam sweeping during the UL TX beam acquisition procedure, and send the qualified DL TX beam information to TRP 860. In action 812, TRP 860 indicates the qualified UL TX beam information to UE 820 if UE 820 performs UL TX beam sweeping. If UE 820 does not perform UL TX beam sweeping, TRP 860 may only need to receive the DL TX measurement report and apply the new DL TX beam accordingly.

FIG. 8B is a flowchart illustrating one or more actions taken by a UE for beam acquisition in RRC connected state based on TRP feedback with a single-bit indicator with the UE having beam correspondence capability, according to an exemplary implementation of the present application. With reference to FIG. 8B, in action 821, UE 820 and TRP 860 are in RRC_CONNECTED state. UE 820 may need to perform beam management or beam acquisition to maintain the link quality. In action 822, UE 820 determines whether it has beam correspondence capability. If the determination of action 822 is Yes, the flowchart proceeds to action 823, where UE 820 notifies TRP 860 that it has beam correspondence capability. In action 824, UE 820 measure/monitors the rough CSI (e.g., Doppler shift, delay spread or angular spread) based on the reference signals (e.g., PT-RS or CSI-RS) from TRP 860. In action 825, UE 820 sends a rough CSI measurement report to TRP 860. In action 826, UE 820 receives a single-bit indicator to indicate whether the CSI is suitable for the simplified procedure. In action 827, UE 820 measures reference signals to perform DL RX beam sweeping to obtain a qualified DL RX beam. In action 828, UE 820 determines whether it is allowed to use the simplified procedure based on the single-bit indicator. If the determination of action 828 is Yes, the flowchart proceeds to action 829, where UE 820 obtains the corresponding UL TX beam information based on BC. In action 830, UE 820 sends feedback of DL TX beam measurement report to TRP 860.

If the determination of action 822 is No, the flowchart proceeds to action 831, where UE 820 notifies TRP 860 that it does not have beam correspondence capability. In action 832, UE 820 measures the specific CSI (e.g., channel matrix or eigen vector) based on the reference signals from TRP 860. In action 833, UE 820 sends the specific CSI measurement report to TRP 860, where the specific CSI measurement report includes measurements of each of the DL RX beams to TRP 860.

In action 834, UE 820 receives a bitmap from TRP 860, where the bitmap is for all DL RX beams from TRP 960. In action 835, UE 820 may measure reference signals to perform DL RX beam sweeping to obtain a qualified DL RX beam. In some implementations, action 835 may be optional as illustrated by the dashed lines.

In action 836, UE 820 determines whether any of the qualified DL RX beams is marked as “True” in the bitmap from TRP 860. If the determination of action 836 is Yes, the flowchart proceeds to action 829, where UE 820 obtains the corresponding UL TX beam information based on BC. If the determination of action 836 is No, or if the determination of action 828 is No, the flowchart proceeds to action 837, where UE 820 sends feedback of DL TX beam measurement report to TRP 860 upon different UL TX beams to perform UL TX beam sweeping. In action 838, UE 820 receives the UL TX beam measurement information from TRP 860 which may include qualified UL TX beam information

FIGS. 8C(i) and 8C(ii) are a flowchart illustrating one or more actions taken by a TRP for beam acquisition in RRC connected state based on TRP feedback with a single-bit indicator with the UE having beam correspondence capability, according to an exemplary implementation of the present application. With reference to FIGS. 8C(i) and 8C(ii), in action 861, TRP 860 receives BC capability information from UE 820. In action 862, TRP 860 determines if UE 820 has beam correspondence capability. If the determination of action 862 is Yes, the flowchart proceeds to action 863, where TRP 860 sends synchronization signals (e.g., PT-RS or CSI-RS) to UE 820 for rough CSI measurement. In action 864, TRP 860 receives a rough CSI measurement report from UE 820. In action 865, TRP 860 sends a single-bit indicator to UE 820, where the single-bit indicator is to indicate whether the CSI is suitable for the simplified procedure.

If the determination of action 862 is No, the flowchart proceeds to action 867, where TRP 860 sends CSI-RS to UE 820 for specific CSI measurement. In action 868, TRP 860 receives a specific CSI measurement report from UE 820. In action 869, TRP sends the bitmap to UE 820, where the bitmap for all DL RX beams from TRP 860.

After either action 865 of 869, the flowchart proceeds to action 866, where TRP 820 starts performing beam management and sends reference signals to UE 820. In action 870, TRP 860 obtains the DL TX beam measurement report from UE 820. In action 870, TRP 860 obtains the DL TX measurement report form UE 820. In action 871, TRP 860 determines whether it needs to send feedback of UL TX beam information to UE 820. If the determination of action 871 is Yes, the flowchart proceeds to action 872, where TRP 860 uses the new DL TX beam to send feedback of the UL TX beam measurement report to UE 820. If the determination of action 871 is No, the flowchart proceeds to action 873, where TRP 860 uses the new DL TX beam for transmission.

### Use Case 2: Embodiment 3—TRP Broadcast Information

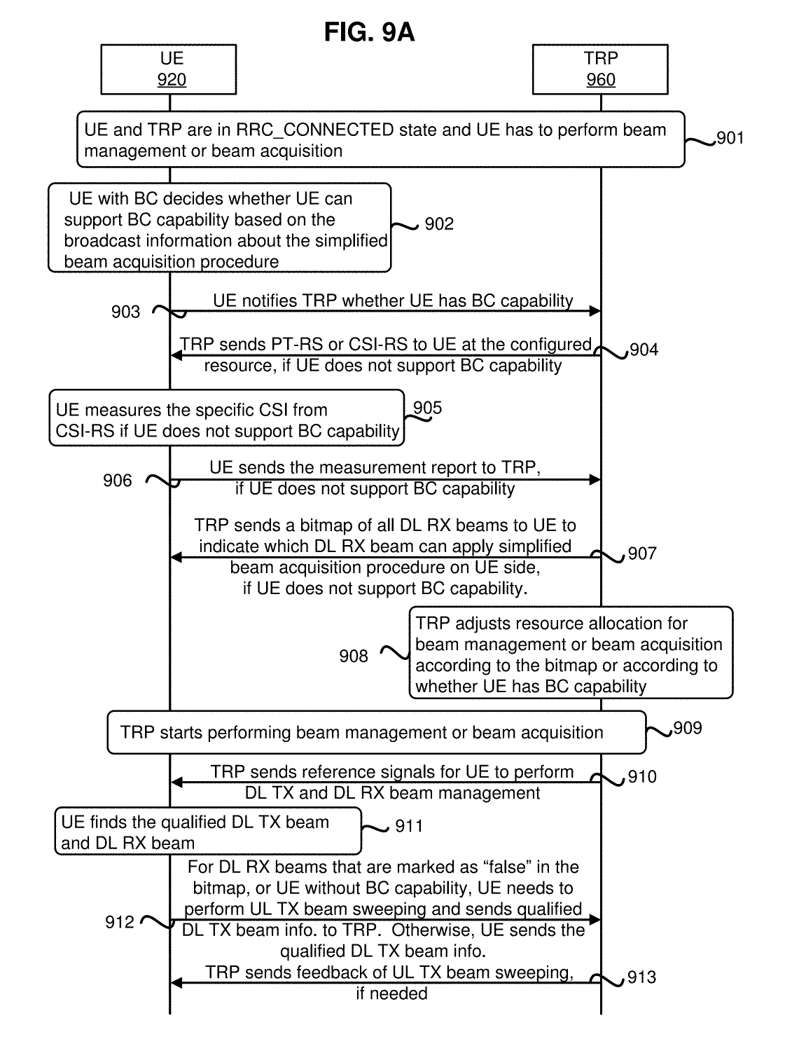

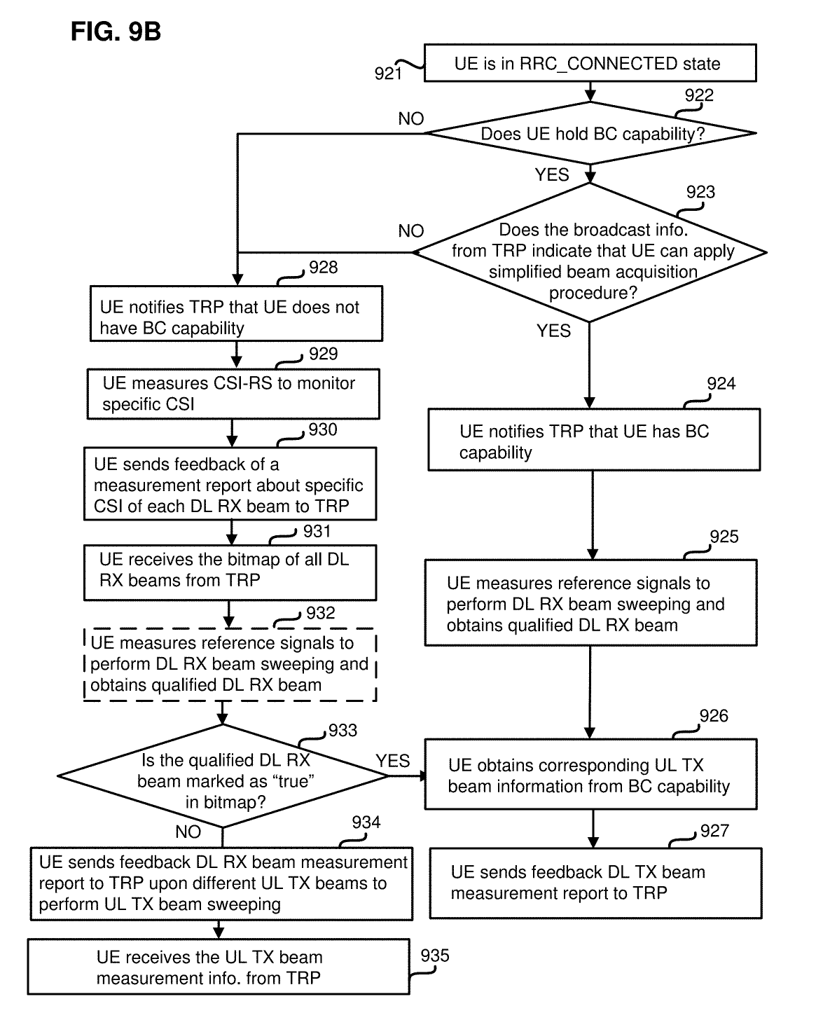

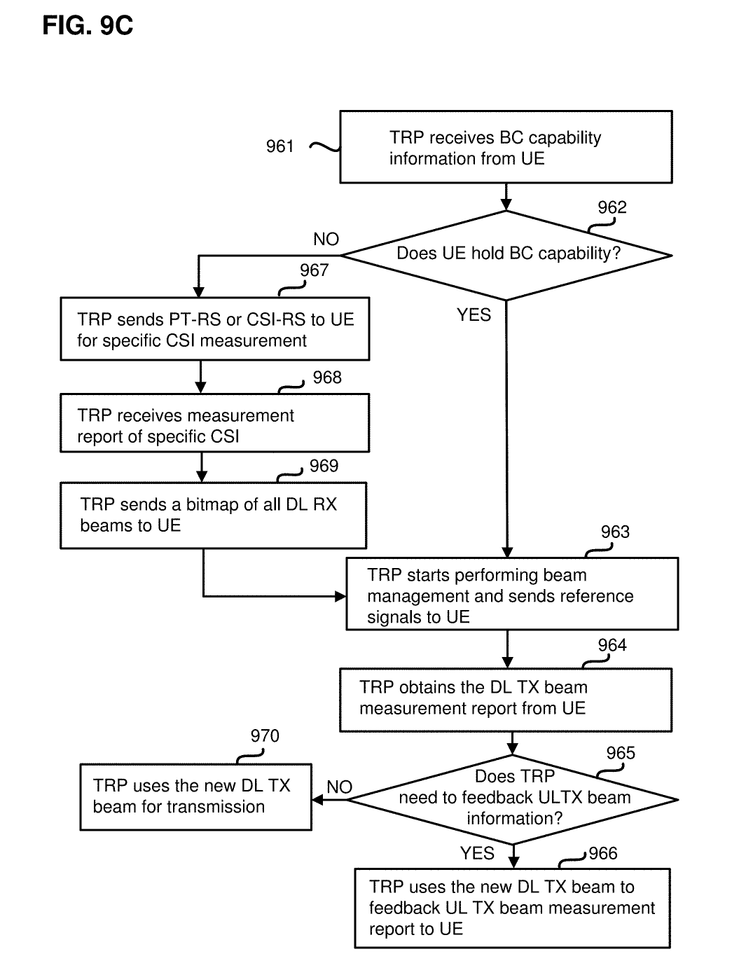

FIG. 9A is a diagram illustrating procedures for beam acquisition in RRC connected state based on broadcast information from the TRP with the UE having beam correspondence capability, according to art exemplary implementation of the present application. With reference to FIG. 9A, in action 901, UE 920 and TRP 960 are in RRC connected state and UE 920 may to perform beam management or beam acquisition to maintain the link quality. In action 902, UE 920 with BC may decide whether UE 920 can support simplify beam acquisition procedure based on the broadcast information. In action 903, UE 920 may notify TRP 960 whether UE 920 can support BC capability. In action 904, TRP 960 may configure reference signals (e.g., PT-RS or CSI-RS) to UE 920 at the dedicated resource. The reference signals may be UE-specific, cell-specific or beam-specific if UE 920 cannot support BC capability. In action 905, if UE 920 does not support BC capability, UE 920 may have to measure the specific CSI (e.g., channel matrix or eigen vector) from reference signals. In action 906, if UE 920 does not support BC capability, UE 920 may send the measurement report to TRP 960. In action 907, TRP 960 may send a bitmap to the UE 920 that cannot support BC capability to indicate whether UE 920 can apply simplified beam acquisition procedure. For the UE 920 that cannot support BC capability, the bitmap will be determined by the specific CSI measurement report of each DL RX beam from UE 920. In the case that UE 920 cannot support BC capability, the bitmap needs to be marked as “False” (e.g. the bit set to “0”) for those DL RX beam that have not been measured yet. In action 908, TRP 960 may adjust resource allocation for beam management or beam acquisition according to the bitmap or according to whether UE 920 holds the BC capability. In action 909, TRP 960 may start performing beam management or beam acquisition to maintain the link quality. In action 910, TRP 960 may send reference signals (e.g., CSI-RS or PTRS) for UE 920 to perform DL TX and DL RX beam management. In action 911, UE 920 may find the qualified DL TX beam and DL RX beam alter measuring different DL TX beam. In action 912, after obtaining a qualified DL RX beam, the UE 920 that can support BC capability can obtain the corresponding qualified UL TX beam based on BC capability. Therefore, the UE 920 that can support BC capability only needs to indicate the qualified DL TX beam to TRP 960. On the other hand, the UE 920 that cannot support BC capability have to check the bitmap from TRP 960. For the DL RX beam that represents “False” in the bitmap, the UE 920 that cannot support BC capability has to perform UL TX beam sweeping during UL TX beam acquisition procedure and sends the qualified DL TX beam to TRP 960. In action 913, TRP 960 may indicate the qualified UL TX beam to UE 920 if UE 920 performs UL TX beam sweeping. If UE 920 does not perform UL TX beam sweeping, TRP 960 may only need to receive the DL TX measurement report and apply the new DL TX beam accordingly.

FIG. 9B is a flowchart illustrating one or more actions taken by a UE for beam acquisition in RRC connected state, based on broadcast information from the TRP with the UE having beam correspondence capability, according to an exemplary implementation of the present application. With reference to FIG. 9B, in action 921, UE 920 and TRP 960 are in RRC connected state. UE 920 may need to perform beam management or beam acquisition to maintain the link quality. In action 922, UE 920 determines whether it has beam correspondence capability. If the determination of action 922 is Yes, then the flowchart proceeds to action 924, where UE 920 notifies TRP 960 that it has beam correspondence capability. In action 925, UE 920 measures reference signals to perform DL RX beam sweeping to Obtain a qualified DL RX beam. In action 926, UE 920 obtains the corresponding UL TX beam information by using BC capability. In action 927, UE 920 sends feedback of DL TX beam measurement report to TRP 960.

If the determination of action 922 or the determination of action 923 is No, then the flowchart proceeds to action 928, where UE 920 notifies TRP 960 that UE 920 does not support BC capability. In action 929, UE 920 measures the specific CSI (e.g., channel matrix or eigen vector) from the reference signals. In action 930, UE 920 sends the specific CSI measurement report to TRP 960, where the specific CSI measurement report includes measurements of each of the DL RX beams to TRP 960.

In action 931, UE 920 receives a bitmap from TRP 960, where the bitmap is for all DL RX beams from TRP 960. In action 932, UE 920 may measure reference signals to perform DL RX beam sweeping to obtain a qualified DL RX beam. In some implementations, action 932 may be optional as illustrated by the dashed lines. In action 933, UE 920 determines whether any of the qualified DL RX beams is marked as “True” in the bitmap from TRP 960. If the determination of action 933 is Yes, the flowchart proceeds to action 936, where UE 920 obtains the corresponding UL TX beam information by using BC capability. If the determination of action 933 is No, the flowchart proceeds to action 934, where UE 920 sends feedback of DL TX beam measurement report to TRP 960 upon different UL TX beams to perform UL TX beam sweeping. In action 935, UE 920 receives the UL TX beam measurement information from TRP 960 which may include qualified UL TX beam information.

FIG. 9C is a flowchart illustrating one or more actions taken by a TRP for beam acquisition in RRC connected state, based on broadcast information from the TRP with the UE having beam correspondence capability, according to an exemplary implementation of the present application. With reference to FIG. 9C, in action 961, TRP 960 receives BC capability information from UE 920. In action 962, TRP 960 determines if UE 920 has beam correspondence capability. If the determination of action 962 is Yes, the flowchart proceeds to action 963, where TRP 920 starts performing beam management and sends reference signals to UE 920. If the determination of action 962 is No, the flowchart proceeds to action 967, where TRP 960 sends synchronization signals (e.g., PT-RS or CSI-RS) to UE 920 for rough CSI measurement. In action 968, TRP 960 receives a specific CSI measurement report from UE 920. In action 968, TRP 960 sends the bitmap to UE 920, where the bitmap for all DL RX beams from TRP 960.

After either action 962 of 969, the flowchart proceeds to action 963, where TRP 960 starts performing beam management and send reference signals to UE. In action 964, TRP 960 obtains the DL TX beam measurement report from UE 920. In action 965, TRP 960 determines whether it needs to send feedback of UL TX beam information to UE 920. If the determination of action 965 is Yes, the flowchart proceeds to action 966, where TRP 960 uses the new DL TX beam to send feedback of the UL TX beam measurement report to UE 920. If the determination of action 965 is No, the flowchart proceeds to action 970, where TRP 966 uses the new DL TX beam for transmission.

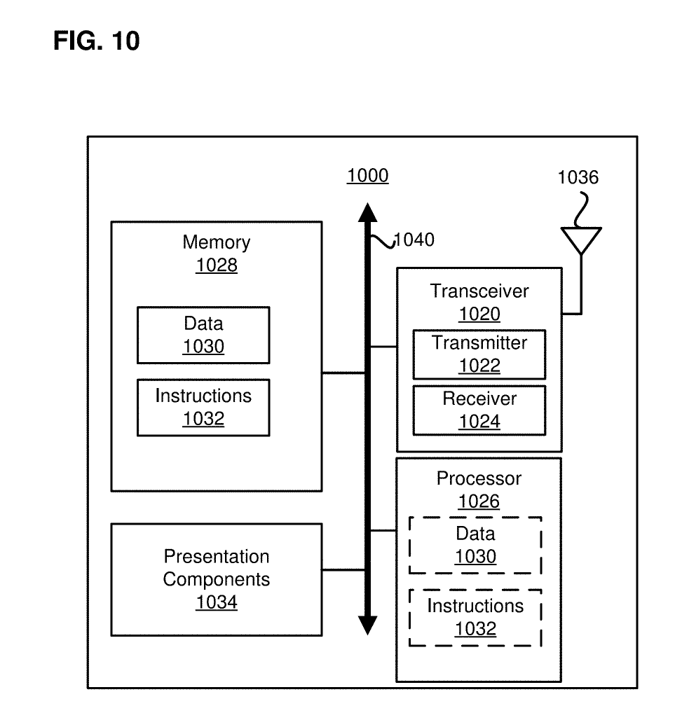

FIG. 10 illustrates a block diagram of a node for wireless communication, in accordance with various aspects of the present application. As shown in FIG. 10, node 1000 may include transceiver 1020, processor 1026, memory 1028, one or more presentation components 1034, and at least one antenna 1036. Node 1000 may also include an RF spectrum band module, a base station communications module, a network communications module, and a system communications management module, input/output (I/O) ports, I/O components, and power supply (not explicitly shown in FIG. 10). Each of these components may be in communication with each other, directly or indirectly, over one or more buses 1040.

Transceiver 1020 having transmitter 1022 and receiver 1024 may be configured to transmit and/or receive time and/or frequency resource partitioning information. In some implementations, transceiver 1020 may be configured to transmit in different types of subframes and slots including, but not limited to, usable, non-usable and flexibly usable subframes and slot formats. Transceiver 1020 may be configured to receive data and control channels.

Node 1000 may include a variety of computer-readable media. Computer-readable media can be any available media that can be accessed by node 1000 and include both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage information such as computer-readable instruct data structures, program modules or other data.

Computer stomp media includes RAM, ROM, EEPROM, flash memory or other memory technology, CD-ROM, versatile disks (DVD) or other optical disk storage, magnetic cassettes, magnetic tape, magnetic disk storage or other magnetic storage devices. Computer storage media does not comprise a propagated data signal. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

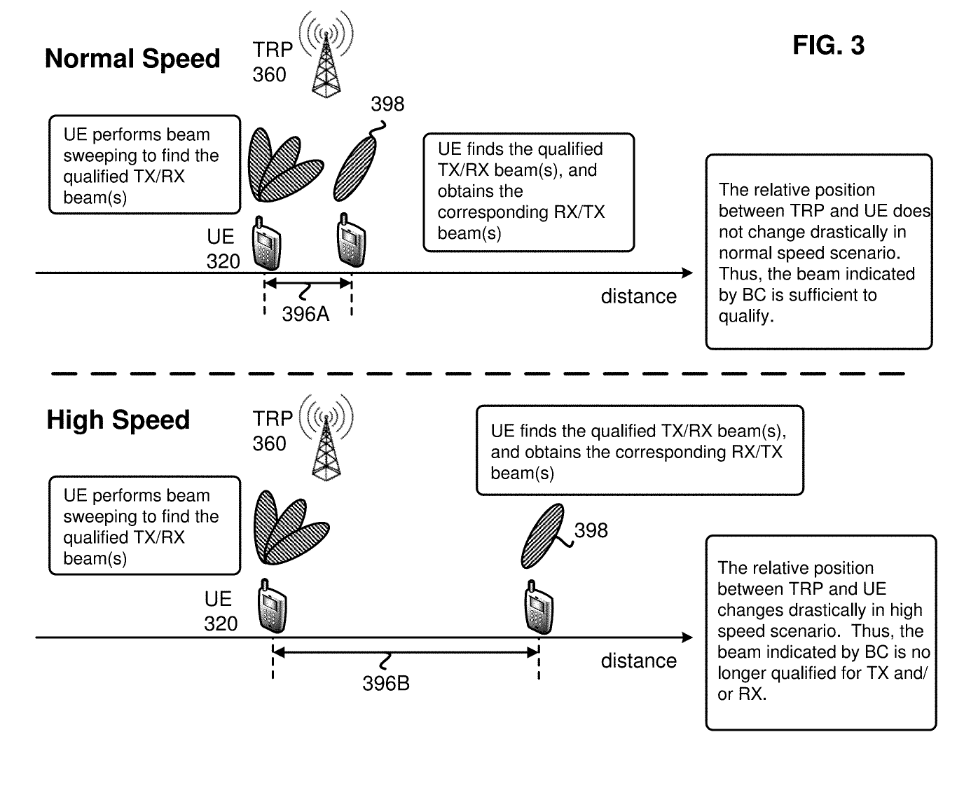

Memory 1128 may include computer-storage media in the form of volatile and/or non-volatile memory. Memory 1028 may be removable, non-removable, or a combination thereof. Exemplary memory includes solid-state memory, hard drives, optical-disc drives, and etc. As illustrated in FIG. 10, memory 1028 may store computer-readable, computer-executable instructions 1032 (e.g., software codes) that are configured to, when executed, cause processor 1026 to perform various functions described herein, for example, with reference to FIGS. 1A through 13B. Alternatively, instructions 1032 may not be directly executable by processor 1026 but be configured to cause node 1000 (e.g., when compiled and executed) to perform various functions described herein.

Processor 1026 may include an intelligent hardware device, e.g., a central processing unit (CPU), a microcontroller, an ASIC, and etc. Processor 1026 may include memory. Processor 1026 may process data 1030 and instructions 1032 received from memory 1028, and information through transceiver 1020, the base band communications module, and/or the network communications module. Processor 1026 may also process information to be sent to transceiver 1020 for transmission through antenna 1036, to the network communications module for transmission to a core network.

One or more presentation components 1034 presents data indications to a person or other device. Exemplary one or more presentation components 1034 include a display device, speaker, printing component, vibrating component, and etc.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A method for beam acquisition between a user equipment (UE) and a transmit-receive point (TRP) in radio resource control connected (RRC_CONNECTED) state, the method comprising:
measuring, by the UE, reference signals from the TRP to form a channel state information (CSI) measurement report;
applying, by the UE, a simplified beam acquisition procedure of a normal beam acquisition procedure, based on at least one of the CSI measurement report and a bitmap from the TRP;
wherein the UE obtains an uplink (UL) transmission (TX) beam based on a qualified downlink (DL) reception (RX) beam using beam correspondence, when the simplified beam acquisition procedure is applied.

2. The method of claim 1, wherein:
when the simplified beam acquisition procedure is applied:
a higher layer parameter SRS-SpatialRelationInfo is set to “CSI-RS” (channel state information reference signal), the UE transmits a sounding reference signal (SRS) resource with the same spatial domain transmission filter used for the reception of a periodic CSI-RS or of a semi-persistent CSI-RS; and
the UE determines a physical uplink shared channel (PUSCH) transmission precoder based on SRS Resource Indicator (SRI);
when the normal beam acquisition procedure is applied:
the UE ignores the SRS-SpatialRelationInfo until the UE receives one or more SRS resource sets for determining a new UL beam.

3. The method of claim 1, wherein the CSI measurement report includes rough CSI measurements of information related to the UE's mobility.

4. The method of claim 1, wherein the reference signals include at least one of synchronization signals, Phase Tracking Reference Signals (PT-RSs), and Channel State Information Reference Signals (CSI-RSs).

5. The method of claim 1, wherein the CSI measurement report includes specific CSI measurements of CSI-RSs.

6. The method of claim 5, wherein the specific CSI measurements include CSI type II report.

7. The method of claim 1, wherein the CSI measurement report includes at least one of rough CSI measurements of CSI-RSs or PT-RSs.

8. The method of claim 7, wherein the rough CSI measurements include all measurements except CSI type II report.

9. The method of claim 1, wherein:
the bitmap from the TRP includes Transmission Configuration Indication (TCI) states to indicate to the UE which of the TCI states are allowed to apply the simplified beam acquisition procedure; and
the TCI states include reference signals for indicating to the UE which DL RX beams are allowed to apply the simplified beam acquisition procedure.

10. The method of claim 9, farther comprising:
adjusting, by the TRP, resource allocation for beam management or beam acquisition according to the bitmap:
wherein the resource for the beam management contains at least one SRS resource or at least one SRS resource set.

11. The method of claim 1, further comprising:
sending, by the TRP, a single-bit indicator to the UE to indicate whether all DL RX beams are allowed to apply the simplified beam acquisition procedure.

12. The method of claim 1, further comprising:
providing, by the UE, the CSI measurement report to the TRP; and
determining, by the UE, the qualified DL RX beam by beam sweeping.

13. A user equipment (UE) for wireless communication, the UE comprising:
one or more non-transitory computer-readable media having computer-executable instructions embodied thereon:
at least one processor coupled to the one or more non-transitory computer-readable media, and configured to execute the computer-executable instructions to:
measure reference signals from the TRP to form a channel state information (CSI) measurement report;
apply a simplified beam acquisition procedure or a normal beam acquisition procedure, based on at least one of the CSI measurement report and a bitmap;
provide the CSI measurement report to the TRP from the TRP;
wherein the UE obtains an uplink (UL) transmission (TX) beam based on a qualified DL RX beam using beam correspondence, when the simplified beam acquisition procedure is applied.

14. The UE of claim 13, wherein:
when the simplified beam acquisition procedure is applied:
a higher layer parameter SRS-SpatialRelationInfo is set to “CSI-RS” (channel state information reference signal), the UE transmits a sounding reference signal (SRS) resource with the same spatial domain transmission filter used for the reception of a periodic CSI-RS or of a semi-persistent CSI-RS; and
the UE determines a physical uplink shared channel (PUSCH) transmission precoder based on SRS Resource Indicator (SRI);
when the normal beam acquisition procedure is applied:
the UE ignores the SRS-SpatialRelationInfo until the UE receives one or more SRS resource sets for determining a new UL beam.

15. The UE of claim 13, wherein the CSI measurement report includes rough CSI measurements of information related to the UE's mobility.

16. The UE of claim 13, wherein the reference signals include at least one of synchronization signals, Phase Tracking Reference Signals (PT-RSs), and Channel State Information Reference Signals (CSI-RSs).

17. The UE of claim 13, wherein the CSI measurement report includes specific CSI measurements of CSI-RSs.

18. The UE of claim 17, wherein the specific CSI measurements include CSI type II report.

19. The UE of claim 13, wherein the CSI measurement report includes at least one of rough CSI measurements of CSI-RSs or PT-RSs.

20. The UE of claim 19, wherein the rough CSI measurements include all measurements except CSI type II report.

21. The UE of claim 13, wherein:
the bitmap from the TRP includes Transmission Configuration Indication (TCI) states to indicate to the UE which of the TCI states are allowed to apply the simplified beam acquisition procedure; and
the TCI states include reference signals for indicating to the UE which DL RX beams are allowed to apply the simplified beam acquisition procedure.

22. The UE of claim 13, wherein the at least one processor is configured to execute the computer-executable instructions to:
receive, from the TRP, a single-bit indicator to indicate whether all DL RX beams are allowed to apply the simplified beam acquisition procedure.

23. The UE of claim 13, wherein the at least one processor is configured to execute the computer-executable instructions to:
provide the CSI measurement report to the TRP; and
determine the qualified DL RX beam by beam sweeping.

24. A method for beam acquisition between a user equipment (UE) and a transmit-receive point (TRP) in an initial access phase, the method comprising:
determining, by the UE, whether a broadcast signal from the TRP indicates that a simplified beam acquisition procedure is allowed;
applying, by the UE, the simplified beam acquisition procedure when the broadcast signal from the TRP indicates that the simplified beam acquisition procedure is allowed;
wherein the UE obtains an uplink (UL) transmission (TX) beam based on a qualified downlink (DL) reception (RX) beam using beam correspondence, when the simplified beam acquisition procedure is applied.

25. The method of claim 24, wherein:
when the simplified beam acquisition procedure is applied:
a higher layer parameter SRS-SpatialRelationInfo is set to “CSI-RS” (channel state information reference signal), the UE transmits a sounding reference signal (SRS) resource with the same spatial domain transmission filter used for the reception of a periodic CSI-RS or of a semi-persistent CSI-RS; and
the UE determines a physical uplink shared channel (PUSCH) transmission precoder based on SRS Resource Indicator (SRI);
when the normal beam acquisition procedure is applied:
the UE ignores the SRS-SpatialRelationInfo until the UE receives one or more SRS resource sets for determining a new UL beam.

26. The method of claim 24, further comprising:
performing, by the UE, DL RX beam sweeping to determine the qualified DL RX beam, when the broadcast signal from the TRP indicates that the simplified beam acquisition procedure is allowed.

27. The method of claim 24, further comprising:
measuring, by the UE, reference signals from the TRP;
wherein the reference signals include at least one of synchronization signals, Phase Tracking Reference Signals (PT-RSs), and Channel State Information Reference Signals (CSI-RSs).
